(19) United States
(12) Patent Application Publication
(10) Pub. No.: US 2022/0284348 A1
(43) Pub. Date: Sep. 8, 2022

(54) SYSTEMS AND METHODS FOR DETERMINING REFERENCE POINTS FOR MACHINE LEARNING ARCHITECTURES

(71) Applicant: Noble Artificial Intelligence, Inc., San Francisco, CA (US)

(72) Inventors: Matthew Chase Levy, San Francisco, CA (US); Brian Willett, Santa Barbara, CA (US); Ashwin Dushyantha Hegde, San Francisco, CA (US)

(21) Appl. No.: 17/686,594

(22) Filed: Mar. 4, 2022

Related U.S. Application Data
(60) Provisional application No. 63/156,898, filed on Mar. 4, 2021.

(51) Int. Cl. G06N 20/00; G06K 9/62

(52) U.S. Cl. CPC G06N 20/00; G06K 9/6215; G06K 9/6251; G06K 9/6298

(57) ABSTRACT

This disclosure relates to improved techniques for determining reference points for computerized simulations of physical systems and/or physical models that may be used in machine learning development architectures. This disclosure also relates to systems, methods, apparatuses, and computer program products that are configured to determine reference points for one or more parameters of a model of a physical system used in a computerized simulation of the model. The reference points may be representative of the system outputs across the parameter space, and can be determined in an efficient and computationally-feasible manner. The outputs of the computerized simulations of physical systems may then be further used to create, build, or train one or more learning models pertaining to physical systems.

### CROSS-REFERENCE TO RELATED APPLICATIONS

The present application claims priority to, and the benefit of, U.S. Provisional Patent Application No. 63/156,898 filed on Mar. 4, 2021. The aforementioned application is herein incorporated by reference in its entirety as if recited in full herein.

### TECHNICAL FIELD

This disclosure is related to improved techniques for determining reference points for computerized simulations of physical systems and physical models that may be used in machine learning development architectures.

### BACKGROUND

For many applications in machine learning, it can be very costly to obtain training data. This may be especially true in fields such as medicine or research and development, in which expensive tests or experiments are typically run to obtain the desired data. In these and other cases, it is important to extract the maximum usable information from this limited data in order to construct the best possible models. In some cases, there is little or no control over what data is received. In this regard, the analysis proceeds on the results of experiments or tests that have already been performed.

In certain cases, however, it is possible to request the data to be analyzed in advance using models of physical systems. One technical problem in requesting such data, however, relates to over-parameterization. Over-parameterization may result in a lack of feasibility in selecting parameters for generating outputs that are representative of their range in the physical system. Another technical problem involves selecting parameters in advance that will allow for high learning rates for machine learning architectures directed to physical systems.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

To facilitate further description of the embodiments, the following drawings are provided, in which like references are intended to refer to like or corresponding parts, and in which:

FIG. 1 is a diagram of an exemplary system according to certain embodiments;

FIG. 2 is a block diagram of an exemplary machine learning development architecture in accordance with certain embodiments;

FIG. 3 is a block diagram of exemplary learning models in accordance with certain embodiments;

FIG. 4 is a block diagram of exemplary reference point determination components in accordance with certain embodiments;

FIG. 5 is a flow chart of an exemplary method for learning in accordance with certain embodiments;

FIG. 6 is a flow chart of an exemplary method for determining reference points in accordance with certain embodiments;

FIG. 7 is an illustration of the set of points a given distance from the origin, which lies at center of an ellipsoid;

FIG. 8 is an illustration of a cylinder with radius r and length l;

FIG. 9 is a plot of an optimal sample of a parameter space according to certain embodiments;

FIG. 10 is a schematic illustration of a coaxial cable;

FIG. 11 is an illustration of plots of meshes of aircraft wings with one of the design parameters changed (with the change exaggerated for illustrative purposes);

FIG. 12 is an illustration of the theta component of a metric as r and theta are varied for an airplane wing design;

FIG. 13 is a plot of an optimal sample of a parameter space according to certain embodiments;

FIG. 14 is a plot of an optimal sample of a parameter space according to certain embodiments;

FIG. 15 is a plot of an optimal sample of a parameter space according to certain embodiments alongside a plot of a random sample of the same parameter space;

FIG. 16 are plots of projections of a d=10 dimensional optimal sampling of a parameter space onto two different subspaces;

FIG. 17 is a plot of an optimal sample of a parameter space according to certain embodiments;

FIG. 18 is a plot of an optimal sample of a parameter space according to certain embodiments;

FIG. 19 is a plot of an optimal sample of a parameter space according to certain embodiments;

FIG. 20 is a plot of an optimal sample of a parameter space according to certain embodiments;

FIG. 21 is a plot of an optimal sample of a parameter space according to certain embodiments;

FIG. 22 is a plot of a metric according to certain embodiments;

FIG. 23 is a plot of an optimal sample of a parameter space according to certain embodiments;

FIG. 24 is a plot of a metric according to certain embodiments;

FIG. 25 is a plot of an optimal sample of a parameter space according to certain embodiments;

FIG. 26 is a plot of expected gain in KL divergence for a single point sampled from the unit interval, [0,1], as a function of position, x, along the interval;

FIG. 27 is a plot of expected gain in KL divergence for two points sampled from the unit interval, [0,1], as a function of positions, x and y, along the interval; and

FIG. 28 is a plot of a lattice used for numerical computation of KL divergence gain for an optimal sample, with N_{lattice}=10.

### DETAILED DESCRIPTION OF EXEMPLARY EMBODIMENTS

The present disclosure relates to systems, methods, apparatuses, and computer program products that are configured to provide a machine learning development architecture that determines, identifies, and/or selects reference points for one or more parameters of a physical system model that may be used in a computerized simulation for a physical system or sensed by one or more sensors. As explained in further detail below, the reference points may be selected and/or determined in a manner that is more representative of the system outputs across a parameter space in comparison to other techniques (e.g., random sampling), and do so in a manner that is computationally feasible. The outputs of the computerized simulations corresponding to the physical systems may then be further used to create, build, and/or train data-driven machine learning models and/or artificial intelligence (AI) models corresponding to physical systems.

The manner in which the machine learning development architecture optimizes the determination of reference points may vary. In certain embodiments, reference points may be determined using correlation metrics that are a proxy for one or more of a model parameter's effects on one or more outputs or characteristics of a physical system. For example, the volume of a shape represented by one or more parameters may be used as part of correlation metric to estimate the effect of varying the parameter on the output of a system (e.g., aerodynamic drag or electrical resistance). The reference points may be determined using other techniques as well.

The functions performed by the machine learning development architecture may be used across a wide variety of scenarios and applications. One useful application is in the context of building, constructing, and/or training machine-learning models. For example, the present technologies may be used to develop machine-learning models for implementing and/or constructing designs pertaining to fluid dynamics, electronic devices, integrated circuits, electrical circuits, automobiles (and/or automobile components), aircraft (and/or aircraft components, e.g., such as aircraft wing designs), and/or many other physical system designs.

While certain portions of this disclosure may describe embodiments in which these functions are applied to computer simulations, it should also be recognized that these functions may be applied to create physical specimens for real-world testing. For example, in some embodiments, the disclosed reference point determination techniques may be used to create physical specimens in rapid-prototyping scenarios. This may be especially useful where the underlying system is difficult to model in a computer and/or in scenarios in which developing an underlying computer model may be prohibitively expensive when compared with specimen creation.

As evidenced by the disclosure herein, the inventive techniques set forth in this disclosure are rooted in computer technologies that overcome existing problems in machine learning and sampling models of physical systems, specifically problems dealing with inefficient and/or prohibitively expensive techniques associated with determining reference points for physical system models and training machine learning models. The techniques described in this disclosure provide a technical solution (e.g., one that utilizes various machine-learning techniques) for overcoming these and other limitations. For example, the machine learning development techniques described herein can determine reference points to be used for a physical system model, whereby the reference points are used to generate outputs that maximize and/or optimize the learning capabilities of one or more learning models (e.g., one or more learning models that are configured to facilitate or optimize the designs of physical systems). In certain embodiments, the outputs of the physical system models at the determined reference points (along with the reference points themselves) may be used generate training vectors that enable the learning models to be trained efficiently and accurately. This technology-based solution marks an improvement over existing capabilities and functionalities related to machine learning, including model-based machine learning of physical systems.

In certain embodiments, a system of one or more computing devices is provided. The one or more computing devices comprise one or more processors and one or more non-transitory storage devices for storing instructions. The execution of the instructions by the one or more processors causes the one or more computing devices to: receive a parameter space definition; determine a correlation metric on a parameter space using the parameter space definition; determine a loss function using the correlation metric; compute a set of reference points using the loss function; generate one or more sensed outputs using the computed reference points; and update a learning model of a machine learning development architecture using a training vector comprised of the reference points and sensed outputs.

In certain embodiments, a method is provided. The method is implemented via execution of computing instructions configured to run at one or more processors and configured to be stored at non-transitory computer-readable media. The method comprises: receiving a parameter space definition; determining a correlation metric on a parameter space using the parameter space definition; determining a loss function using the correlation metric; computing a set of reference points using the loss function; generating one or more sensed outputs using the computed reference points; and updating a learning model of a machine learning development architecture using a training vector comprised of the reference points and sensed outputs.

In certain embodiments, a computer program product is provided. The computer program product comprises a non-transitory computer-readable medium including instructions. The instructions are for causing a computer to: receive a parameter space definition; determine a correlation metric on a parameter space using the parameter space definition; determine a loss function using the correlation metric; compute a set of reference points using the loss function; generate one or more sensed outputs using the computed reference points; and update a learning model of a machine learning development architecture using a training vector comprised of the reference points and sensed outputs.

The embodiments described in this disclosure may be combined in various ways. Any aspect or feature that is described for one embodiment may be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features or components as being implemented in software or hardware, it should be recognized that any embodiment, feature or component that is described in the present application may be implemented in hardware and/or software.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium may be a magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements may include local memory employed during actual execution of the program code, bulk storage, and cache memories, which provide temporary storage of at least some program code to reduce the number of times, code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

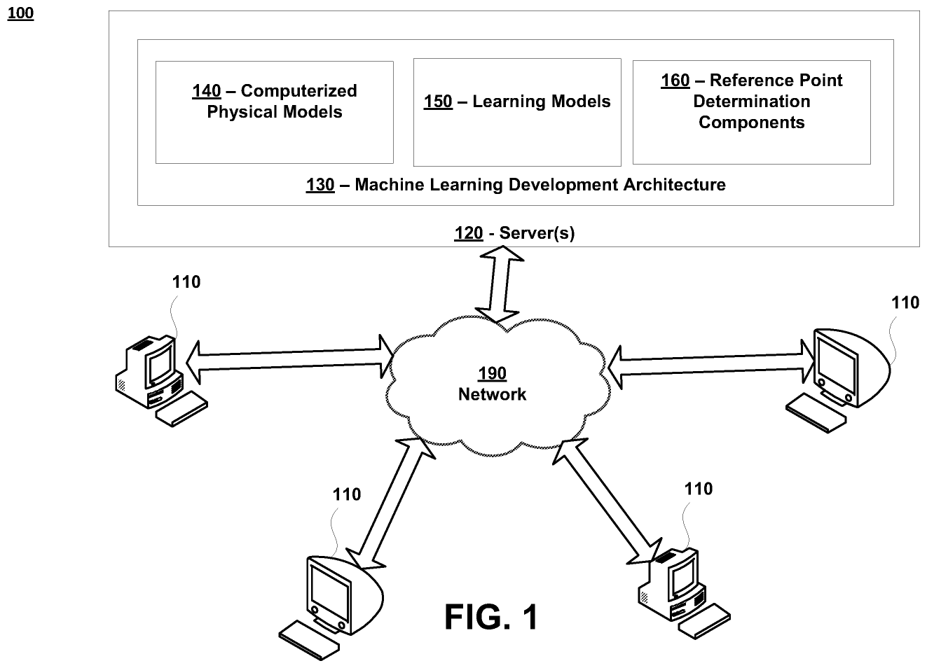

FIG. 1 is a diagram of an exemplary system 100 in accordance with certain embodiments. In certain embodiments, the system 100 comprises one or more computing devices 110 and one or more servers 120 that are in communication over a network 190. A machine learning development architecture 130 is stored on, and executed by, the one or more servers 120. The machine learning development architecture 130 includes one or more computerized physical models 140, one or more learning models 150, and/or one or more reference point determination components 160. The system 100 may include any number of computing devices 110, servers 120, machine learning development architectures 130, computerized physical models 140, learning models 150, and/or reference point determination components 160.

The network 190 may represent any type of communication network, e.g., such as one that comprises the Internet, a local area network (e.g., a Wi-Fi network), a personal area network (e.g., a Bluetooth network), a wide area network, an intranet, a cellular network, a television network, and/or other types of networks. All the components illustrated in FIG. 1, including the computing devices 110, servers 120, and machine learning development architectures 130 (including any sub-components), may be configured to communicate directly with each other and/or over the network 190 via wired or wireless communication links, or a combination of the two. Each of the computing devices 110, servers 120, and/or machine learning development architectures 130 may also be equipped with one or more transceiver devices, one or more computer storage devices (e.g., RAM, ROM, PROM, SRAM, etc.), and one or more processing devices that are capable of executing computer program instructions.

The one or more processing devices may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions.

The one or more computer storage devices may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the computer storage devices may be physical, non-transitory mediums.

In certain embodiments, the computing devices 110 may represent desktop computers, laptop computers, mobile devices (e.g., smart phones, personal digital assistants, tablet devices, vehicular computing devices, wearable devices, and/or any other device that is mobile in nature), and/or other types of devices. The one or more servers 120 may generally represent any type of computing device, including any of the computing devices 110 mentioned above. In certain embodiments, the one or more servers 120 comprise one or more mainframe computing devices that execute web servers for communicating with the computing devices 110, and/or other applications and devices over the network 190 (e.g., over the Internet). In certain embodiments, the one or more servers may represent cloud-based servers and/or servers associated with providing a software-as-a-service (SaaS).

In some cases, machine learning development architecture 130 may be implemented as a local application (e.g., an application that is stored and/or execute locally on a computer device 110 and/or server 120). Additionally, or alternatively, the machine learning development architecture 130 may represent a SaaS platform and/or cloud-based application that runs on the one or more servers 120, and which is accessible over the network 190. In certain embodiments, organizations and/or users may create accounts on the machine learning development architecture 130. In certain embodiments, in response to a user creating an account on the machine learning development architecture 130, the users may access interfaces and/or applications that permit users to perform the functions associated with the machine learning development architecture 130.

The machine learning development architecture 130 may be configured to perform any and all functions described herein with respect to building, generating and/or training learning models 150, and generating training data for training learning models 150. As explained in further detail below, in certain embodiments, the machine learning development architecture 130 may be configured to use various techniques that cause the computerized physical models 140 to optimally generate outputs to be used in training learning models 150.

The computerized physical models 140 may generally represent any model that simulates and/or represents one or more physical systems. In some cases, the computerized physical models 140 may simulate and/or represent a physical system corresponding to fluid dynamics, electronic devices, integrated circuits, electrical circuits, automobiles (and/or automobile components), aircraft (and/or aircraft components, e.g., such as aircraft wing designs), particles (e.g., groups of molecules, individual molecules, atoms, ions, sub-atomic particles, electrons, protons, neutrons, etc.), and/or other physical systems. In certain embodiments, the computerized physical models 140 may generate real-world simulations that utilize and solve equations representing relevant laws of nature. In some examples, each computerized physical model 140 may be configured to provide a numerical simulation and/or other simulation that has been extensively tested for accuracy, debugged, benchmarked, and confirmed to agree with experimental reality.

In certain embodiments, the physical systems simulated and/or represented by computerized physical models 140 may be modeled using a set of input parameters. By setting the input parameters of a computerized physical model 140, one or more computers implementing or executing the computerized physical model 140 may simulate the likely outputs of the physical system under study. In one example, the studied physical system may be an automobile design, with one objective being to produce the most aerodynamic shape that minimizes the drag. As another example, the studied physical system may be the design of an antenna, with a goal of optimizing the antenna efficiency and directivity. In these and other examples, parameters of the computerized physical model 140 may specify the geometry of the physical system, natural laws applicable to the physical system, materials used by the physical system, and/or other relevant properties of the physical system.

Data-driven models corresponding to physical systems are often parameterized by a large number of input parameters (over-parameterization). This over-parameterization results in a combinatorially-large parameter space, which renders simulation of the physical systems across the entire parameter space impractical or impossible.

To address these and other technical difficulties, the reference point determination component 160 may execute various functions for selecting reference data points to be used as input parameters for each of the computerized physical models 140. As explained below, the reference point determination component 160 may select the reference points in manner that maximizes the utility of the outputs with respect to training and/or building learning models 150, and which reduces simulation to a computationally-feasible parameter space.

To facilitate the building and execution of the data-driven, computerized physical models 140, the reference point determination component 160 selects or determines the reference data points corresponding to the parameters by sampling inputs to a finite number (N) of computer simulations. The selection of parameters in the (N) computer simulations is performed in a manner that is representative of the range of system outputs. The simulation outputs of the computerized physical models 140 at the selected reference points may then be used in various machine learning applications. For example, in some cases, the outputs of each computerized physical model 140 may be utilized to generate, construct, and/or train one or more learning models 150.

The configurations of the one or more learning models 150, as well as the functions performed by the one or more learning models 150, may vary significantly. In some cases, each learning model 150 may include one or more neural network models, one or more machine learning models, and/or one or more AI models that are configured to assess, evaluate, and/or test a physical design of a particular physical system. For example, separate learning models 150 may be configured and trained to assess, evaluate, and/or test the physical design an electronic device, integrated circuit, electrical circuit, automobile (and/or automobile component), aircraft (and/or aircraft component), and/or particle structure or composition. One or more learning models 150 may be trained and configured to perform other functions as well. Regardless of the functionality performed by learning models 150, each of learning models 150 may be trained and/or constructed, at least in part, using the outputs of the computerized physical models 140 that are customized according to the reference data points selected by the reference point determination component 160.

In the exemplary system 100 shown in FIG. 1, the machine learning development architecture 130 is stored on, and executed by, the one or more servers 120. In other exemplary systems, the machine learning development architecture 130 may additionally, or alternatively, be stored on, and executed by, the computing devices 110 (e.g., stored as a local application on a computing device 110 to implement the techniques described herein).

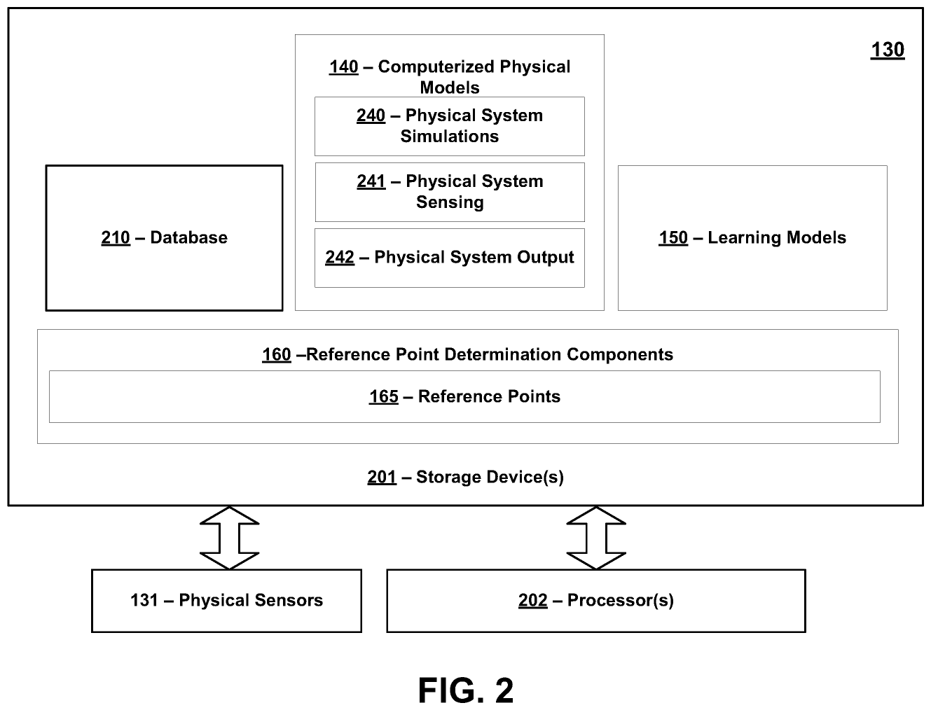

FIG. 2 is a block diagram of a machine learning development architecture 130 in accordance with certain embodiments. The machine learning development architecture 130 includes one or more storage devices 201 that are in communication with one or more processors 202. The one or more storage devices 201 may include: (i) non-volatile memory, such as, for example, read only memory (ROM) or programmable read only memory (PROM); and/or (ii) volatile memory, such as, for example, random access memory (RAM), dynamic RAM (DRAM), static RAM (SRAM), etc. In these or other embodiments, storage devices 201 may comprise (i) non-transitory memory and/or (ii) transitory memory. The one or more processors 202 may include one or more central processing units (CPUs), controllers, microprocessors, digital signal processors, and/or computational circuits. The one or more storage devices 201 may store data and instructions associated with a database 210, computerized physical models 140 that may comprise physical system simulations 240, physical system sensing 241, and/or physical system output 242, learning models 150, and a reference point determination component 160 that may include reference points 165. The one or more processors 202 are configured to execute instructions associated with these components. Each of these components is described in further detail below.

Machine learning development architecture 130 may include one or more sensors 131 for sensing a physical environment. Sensors 131 may be any type of sensor. For example, sensors 131 may include accelerometers, gyroscopes, image sensors, x-ray detectors, airflow sensors, microphones, etc. Additional sensors 131 may include biometric sensors (e.g., heart rate sensors), touch sensors, magnetic contact sensors, heat sensors, gas sensors, pressure sensors, infrared (IR) sensors, proximity sensors, light sensors, temperature sensors, acoustic sensors, audio sensors, video sensors, imaging sensors, and/or other types of sensors.

Machine learning development architecture 130 may include one or more computerized physical models 140. As mentioned above, each of the computerized physical models 140 generally may be configured to generate physical system output 242 based on a set of parameters. Computerized physical models 140 may be any suitable model, examples of such models are reduced order models, digital twins, surrogate models, data models. Finite Element Analysis (FEA), including Computational Fluid Dynamics (CFD) and others.

Physical system output 242 may represent one or more characteristics of a physical system under test. In certain embodiments, reference points 165 may be an input to computerized physical models. For example, physical system simulations 240 may be used to generate physical system output 242 based on a computerized simulation of a physical system using input data such as reference points 165. As another example, physical system sensing 241 may be used to generate physical system output 242 using input data such as reference points 165 to control physical sensors 131 and/or store data associated or read from physical sensors 131.

Exemplary embodiments of the machine learning development architecture 130 and the aforementioned sub-components (e.g., database 210, computerized physical models 140, physical system simulations 240, physical system sensing 241, physical system outputs 242, learning models 150, reference point determination component 160, reference points 165) are described in further detail below. While the sub-components of the machine learning development architecture 130 may be depicted in FIG. 2 as being distinct or separate from one other, it should be recognized that this distinction may be a logical distinction rather than a physical distinction. Any or all of the sub-components may be combined with one another to perform the functions described herein, and any aspect or feature that is described as being performed by one sub-component may be performed by any or all of the other sub-components. Also, while the sub-components of the machine learning development architecture 130 may be illustrated as being implemented in software in certain portions of this disclosure, it should be recognized that the sub-components described herein may be implemented in hardware and/or software.

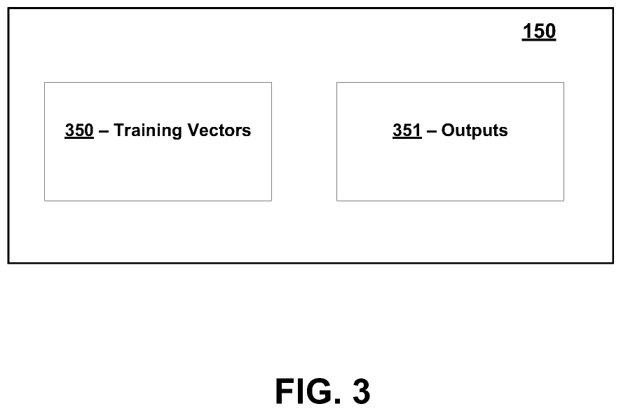

FIG. 3 represents an exemplary embodiment of a learning model 150. In certain embodiments, learning model 150 is configured to develop an accurate model of an underlying distribution of a function y(x). In certain embodiments, a maximum-likelihood (ML) is used to model the distribution of y(x). In certain embodiments, x is a parameter space of an experiment and y is some target (output) of interest. As discussed above, x may be the parameters of a physical system or a computerized model of a physical system. While y may be a trait or characteristic of the physical system that may be derived from x via computation of the computerized model and/or observed by one or more sensors. For example, x may represent the shape of an airplane wing, while y may represent a lift characteristic of the wing.

In certain embodiments, learning model 150 may include one or more training vectors 350. In certain embodiments, training vectors 350 includes, or is derived from, one or more reference points (e.g., reference points 165 of FIG. 2) and/or physical system outputs (e.g., physical system output 242 of FIG. 2). In some cases, each training vector 350 may represent a numerical representation and/or embedding that captures features and/or parameters associated with the one or more reference points and/or physical system outputs. In certain embodiments, learning model 150 may include one or more learning models 150. The types and configurations of the learning models 150 may vary significantly. Learning models 150 may generally represent any type of machine learning model, artificial intelligence (AI) model, and/or neural network model. In certain embodiments, training vectors 350 may be received as inputs included in the learning model 150 (e.g., for training the learning models 150).

In some embodiments, one or more of the learning models 150 may represent a machine learning model. Exemplary machine learning models may include unsupervised and/or supervised machine learning models. Examples of unsupervised machine learning models include clustering (for example k-means, mixture models, hierarchical clustering), and techniques for learning latent variable models, such as Expectation-Maximization algorithm (EM), method of moments or blind signal separation techniques (for example principal component analysis, independent component analysis, non-negative matrix factorization or singular value decomposition). Examples of supervised learning models include Support Vector Machines, linear regression, logistic regression, neural networks, random forest and nearest neighbor methods.

In some embodiments, one or more of the learning models 150 may represent a neural network model that may be configured to optimize the design of physical systems and/or execute deep learning functions. Each neural network model may include a plurality of layers including, but not limited to, one or more input layers, one or more output layers, one or more convolutional layers (e.g., that include learnable filters), one or more ReLU (rectifier linear unit) layers, one or more pooling layers, one or more fully connected layers, one or more detection layers, one or more up/down sampling layers, one or more normalization layers, etc. The configurations of the neural network models and their corresponding layers enable the neural network models to learn and execute various functions for analyzing, interpreting, understanding, and optimizing the traits of a physical system. Other configurations of learning models 150 may also be developed utilizing the machine learning development architecture 130 described herein.

In certain embodiments, learning models 150, including neural network models, or other neural network structures may be trained to learn functionality for changing certain parameters representing aspects of a physical system or evaluating the effects thereof, including but not limited to: physical properties (e.g., dimensions, materials, surface properties, etc.), and/or electromagnetic properties (e.g., frequencies, voltages, etc.). Learning models 150 may be trained to learn any or all of the aforementioned functions.

Learning models 150 may generate one or more outputs 351, which may vary based on the learning tasks associated with the learning models 150. In certain embodiments, a learning model 150 may generate one or more outputs 351 associating with the evaluating and/or optimizing a physical design of a physical system. In some cases, the outputs 351 may include the aforementioned parameters that are used to represent aspects of a physical system and/or evaluating the effects on a physical system.

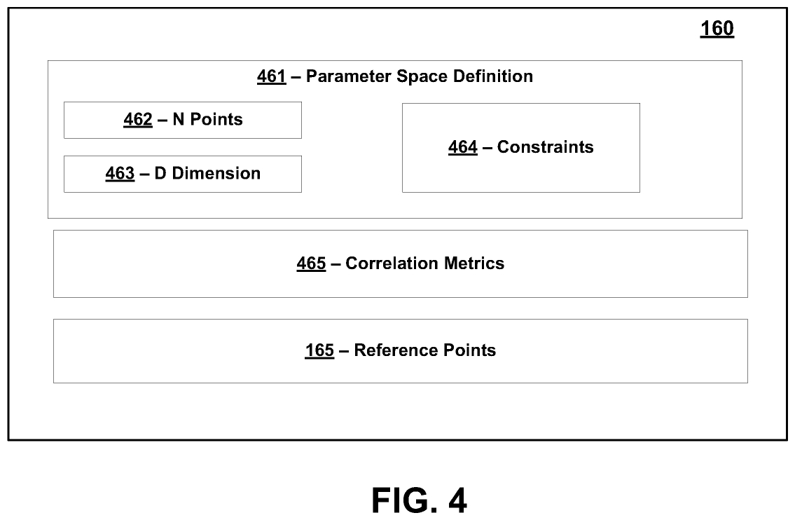

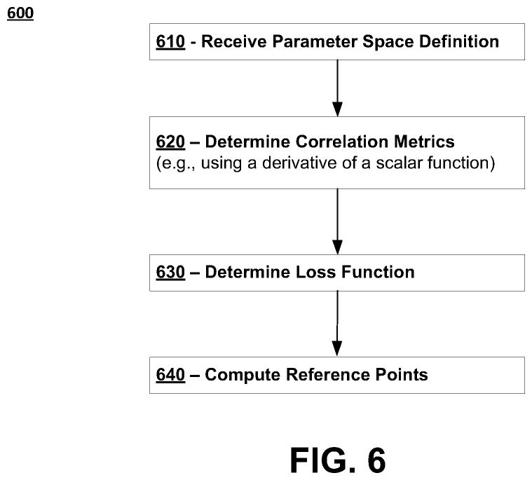

FIG. 4 represents an exemplary embodiment of a reference point determination component 160. In certain embodiments, reference point determination component 160 is configured to determine reference points 165. For example, in some embodiments, the reference point determination component 160 may be configured to perform one or more steps with respect to FIG. 6 to generate one or more sets of reference points 165. In certain embodiments, reference point determination component 160 is configured to determine reference points 165 for machine learning development architecture 130. For example, reference point determination component 160 may be used to determine one or more reference points 165 that may be used by computerized physical models, e.g., computerized physical models 140 of FIG. 1 and/or FIG. 2 to generate one or more physical system outputs 242.

In certain embodiments, reference point determination component 160 may determine one or more reference points 165 using a parameter space definition 461 and one or more correlation metrics 465. Parameter space definition 461 (including exemplary sub components N Points 462, D Dimension 463, and Constraints 464), correlation metrics 465, and reference points 165 are discussed in further detail with respect to FIG. 6 below.

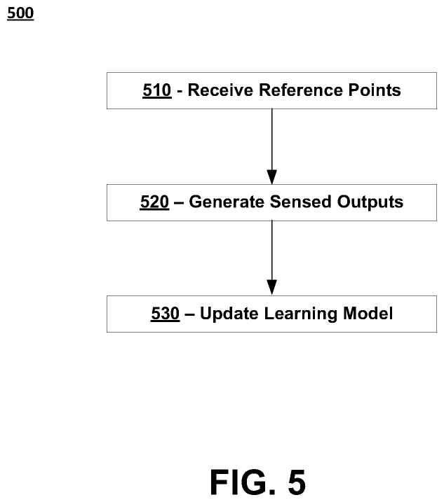

FIG. 5 illustrates a flow chart for an exemplary method 500 according to certain embodiments. Method 500 is merely exemplary and is not limited to the embodiments presented herein. Method 500 may be employed in many different embodiments or examples not specifically depicted or described herein. In some embodiments, the steps of method 500 may be performed in the order presented. In other embodiments, the steps of method 500 may be performed in any suitable order. In still other embodiments, one or more of the steps of method 500 may be combined or skipped. In many embodiments, system 100, one or more computing devices 110, one or more servers 120, and/or one or more machine learning development architectures 130 may be suitable to perform method 500 and/or one or more of the steps of method 500. In certain embodiments, method 500 is performed by one or more learning models 150. In these or other embodiments, one or more of the steps of method 500 may be implemented as one or more computer instructions configured to run at one or more processing modules (e.g., processor 202) and configured to be stored at one or more non-transitory memory storage modules (e.g., storage device 201). Such non-transitory memory storage modules may be part of a computer system such as system 100, one or more computing devices 110, one or more servers 120, and/or one or more machine learning development architectures 130.

At step 510, one or more sets of reference points (x) may be determined and/or received. A set of reference points may represent one or more values of a parameter space as inputs for one or more models. Models may be physical systems or computerized models (simulations) of physical systems. In certain embodiments, received reference points may be reference points 165 discussed above, which may be generated by reference point determination components 160, as also discussed above.

At step 520, one or more sensed outputs (y) may be generated based on the reference points and one or more models. Sensed outputs generally represent one or more characteristics or traits of a physical system represented by a model at the one or more reference points. In certain embodiments, one or more physical representations of an object may be created based on the one or more sets of reference points. Sensed outputs may be generated by sensing one or more characteristics using sensors designed to sense the traits. For example, if a resistor was being designed or created, an ohmmeter may be used to sense a resistance trait of the resistor. In certain embodiments, sensed outputs may be generated by a computer simulation of a computerized model of physical system evaluated at the one or more sets of reference points. In certain embodiments, sensed outputs may be physical system outputs 242 discussed above, which may be generated by computerized physical models 140, also discussed above.

At step 530, a learning model may be updated based on the one or more sets of reference points and/or one or more sensed outputs, which may be used as a training vector. In certain embodiments, an ML model is used to describe a function y(x). In certain embodiments, y(x) is modeled as a random variable with some assumed prior distribution. In certain embodiments, the assumed prior distribution gets Bayesian updates based on the received sample of the parameter space (which may include the training vectors, reference points, and/or sensed outputs described herein).

In certain embodiments, it may be preferable to select reference points to maximize the information gain from the updated distribution. This choice will typically depend intricately on the prior distribution. In certain embodiments, it may be preferable to maximize the information gain based on Kullback-Leibler (KL) divergence. In certain embodiments, maximizing the information gain based on the KL divergence may be accomplished by selecting sample points, x, such that the expected gain in KL divergence is maximized with respect to these points. According to the KL divergence, the information gained when the prior distribution, Q, is updated to the new distribution, P, is:

$${D}_{K L} ( P ‖ Q ) = {\sum }_{χ} P ( x ) log ( \frac{P ( x )}{Q ( x )} ) \qquad ( 1 )$$

where: x runs over the sampling points;
P is the prior probability distribution;
and Q is the new probability distribution.

In certain embodiments, reference points may be selected using a reference point determination component 160 in order to maximize the expected gain in KL divergence.

FIG. 6 illustrates a flow chart for an exemplary method 600 according to certain embodiments. Method 600 is merely exemplary and is not limited to the embodiments presented herein. Method 600 may be employed in many different embodiments or examples not specifically depicted or described herein. In some embodiments, the steps of method 600 may be performed in the order presented. In other embodiments, the steps of method 600 may be performed in any suitable order. In still other embodiments, one or more of the steps of method 600 may be combined or skipped. In many embodiments, system 100, one or more computing devices 110, one or more servers 120, and/or one or more machine learning development architectures 130 may be suitable to perform method 600 and/or one or more of the steps of method 600. In certain embodiments, method 600 is performed by one or more reference point determination components 160. In these or other embodiments, one or more of the steps of method 600 may be implemented as one or more computer instructions configured to run at one or more processing modules (e.g., processor 202) and configured to be stored at one or more non-transitory memory storage modules (e.g., storage device 201). Such non-transitory memory storage modules may be part of a computer system such as system 100, one or more computing devices 110, one or more servers 120, and/or one or more machine learning development architectures 130.

As discussed above, reference point determination component 160 may be used to sample a parameter space as part of a training procedure in a machine learning development architecture. In certain embodiments, as discussed above, reference point determination component 160 may be configured to determine reference points in order maximize an information gain, such as an expected gain in KL divergence, during training.

As discussed above, it is desirable to maximize the expected information gain from obtaining the results of the chosen simulations. For this, it may be beneficial to formulate some prior assumptions on the underlying distribution of the data (e.g., assumptions on the correlations between the outputs at different parameter values). For example, if correlations between outputs at different parameter values were not expected, an algorithm could do no better than random search. However, a basic assumption typically made is that nearby points in parameter space will have similar outputs (continuity). This is a basic assumption across ML. This means that there will be a strong correlation between nearby points in parameter space.

In certain embodiments, reference point determination component 160 may make assumptions on an underlying distribution. In certain embodiments, these assumptions may be minimal.

One important aspect of certain embodiments of reference point determination component 160 is a “correlation metric” (e.g., correlation metric 465). A “correlation metric” is used for measuring distance between two points in the parameter space. Generally, the further away two points are, the less correlated are their outputs. The choice of correlation metric reflects assumptions about the output as a function of the parameter space. The correlation metric may be informed by basic physical principles (such as continuity), scaling laws, more detailed domain knowledge, or even the results of simple models. In certain embodiments, the techniques disclosed herein allow for computing distance metrics in parameter space based on generalized difference metrics that may be computed on simulation conditions without first running simulations in advance.

The “correlation metric” directly impacts the output of reference point determination component 160. For example, more accurate correlation metrics increases the expected information gain when training a learning model via sampling and obtaining the outputs of experiments (e.g., simulations or sensing of physical models).

At step 610, a parameter space definition (e.g., parameter space definition 461) may be received. Parameter space definition may include an indication of the dimension (d) of a parameter space (e.g., D Dimension 463), which may represent or indicate the number of parameters in the parameter space. As discussed above, a parameter space may be related to a physical system or a computer simulation of a physical system. For example, a parameter space may be used to define the shape of one or more objects, such as an airplane wing, automobile body, and/or a resistor. A parameter space definition may also include an indication of the desired number (N) of reference points (e.g., N Points 462) in the parameter space to determine/sample. Generally, each determined reference point from 1 to N may be an n-tuple of the dimensionality d of the parameter space. Typically, for each of the determined reference point one or more output characteristics of the system under test may be generated. In certain embodiments, output characteristics of the physical system under test may be generated via computation of a model representing the system. In certain embodiments, output characteristics of the physical system under test may be observed via one or more sensors configured to sense the physical system.

In certain embodiments, a parameter space definition may include one or more constraints (e.g., Constraints 462) for one or more parameters in the parameter space. In certain embodiments, a constraint may include an indication of a range (bounds) of one or more parameters in the parameter space. For example, if a parameter is indicative of a physical property a range (bound) may specify one or more limits for that parameter. To clarify further, if a parameter is indicative of the tallest point of an automobile, a received range for that parameter may limit the value of that parameter to be between 3 and 7 feet. A constraint, however, may be any constraint on one or more parameters of the parameter space. One type of a constraint is an inequality. For example, a constraint may require that one parameter be greater than another parameter (e.g., y>x). To illustrate further, where x represents an interior dimension and y represents an exterior dimension, it may be impossible for x to exceed y.

In step 620, one or more correlation metrics may be determined. Generally, it is assumed that points in parameter space that are “farther apart” have outputs that are less correlated. A correlation metric is a distance metric on the parameter space, which clarifies the notion of “farther apart.” In certain embodiments, every direction in parameter space may be assumed to be equally weighted in this metric. However, in many realistic applications, some directions will lead to steeper declines in correlation than others, which can be better accounted for by a non-trivial correlation metric.

In the absence of data resulting from an experiment (e.g., simulation or sensing of a physical model), a determined correlation metric will likely be a crude approximation to the true correlation behavior on the parameter space. In certain embodiments, the application of domain knowledge may be used to determine one or more correlation metrics, which may increase expected information gain from the determined reference/sample points. In certain embodiments, improved physics-based techniques for determination of reference points are provided for a fixed number of samples (N), which (N) may be determined by constraints (time, money, or other user constraints) or perhaps other constraints, such as computational capacity limitations.

A general correlation metric may take the form:

$$d {s}^{2} = {\sum }_{i , j = 1}^{M} {g}_{ij} d {x}_{i} {dx}_{j} \qquad ( 2 )$$

where: M is the parameter space dimension;
i is a parameter index;
j is a parameter index;
dx is the differential element on parameter space;
and g is the symmetric, positive-definite matrix.

In certain embodiments, a metric may be determined by scaling or weighting. For example, if a larger variation is expected over a range of a first parameter than over that of another parameter, a larger weighting in the metric may be assigned to the range of the first parameter.

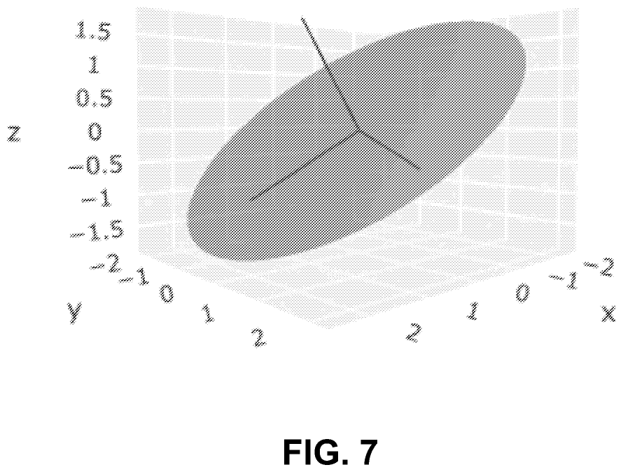

Metrics may be diagonal or not. A metric determines the distance to nearby points. Generally, the set of points of some fixed distance will form an ellipsoid in parameter space, as shown in FIG. 7. In certain cases, all points on the ellipsoid will be assumed to have the same degree of correlation with the point at the center. When the metric is diagonal, the axes of this ellipsoid will be aligned with the coordinate axes, but in general, this need not be the case. The principal axes of the ellipsoid may be constructed in the following manner: By first finding the direction away from the center where the correlation drops the fastest: this is the major axis of the ellipsoid, and the direction in which the metric is the largest. Then, determine the next largest direction orthogonal to this one, and iterate this process until all axes of the ellipsoid are determined. This procedure is analogous to the determination of the principal axes in principal component analysis (PCA). For more information see, Karl Pearson F. R. S. Liii. on lines and planes of closest fit to systems of points in space. The London, Edinburgh, and Dublin Philosophical Magazine and Journal of Science, 2(11):559-572, 1901.

In certain embodiments, a correlation metric may be constant. In certain embodiments, a correlation metric may depend on the parameters. One advantage of the metric is that it is naturally coordinate-covariant. That is, if a linear rescaling of the parameters is made:

$${x}_{i} \to {\tilde{x}}_{i} = {\sum }_{j} {A}_{ij} {x}_{j} \qquad ( 3 )$$

where: x is the original coordinate;
\acute{x} is the transformed coordinate;
i is a coordinate index;
j is a coordinate index;
and A is the coordinate transformation matrix.
   And provided the metric is transformed as:

$${g}_{ij} \to {\tilde{g}}_{ij} = {\sum }_{k , l} {A}_{i k}^{- 1} {A}_{lj}^{- 1} {g}_{ij} \qquad ( 4 )$$

where: g is the metric in the original coordinate system;
\tilde{g} is the metric in the transformed coordinate system;
i is a coordinate index;
j is a coordinate index;
k is a coordinate index;
l is a coordinate index;
and A is the coordinate transformation matrix.
   Then all distances will be preserved, leading to a natural coordinate-independent formulation.

One purpose of method 600 is to capture the variation of the outputs across the parameter space by determining N reference points. Generally, it is desirable to sample regions of the parameter space where there are larger fluctuations in the output than regions with smaller fluctuations. In the absence of output data, it is still possible to use the input data to make some calculations.

In certain embodiments, an output approximation function may be used to estimate the variation in the output. In certain embodiments, an output approximation function is a scalar function whose variation may be used as a proxy or approximation for the variation in the output. More precisely, given a parameter space

[symbol]

S: [symbol] → [symbol] (5)

where: S is a scalar function;
[symbol] is the parameter space;
and [symbol] is the set of real numbers.

The basic idea of an output approximation function is to assign a scalar value to every point in the parameter space. In certain embodiments, one or more derivatives of this function provides a metric on the parameter space by capturing or estimating the variation across the parameter space.

For example, when dealing with design parameters directed to geometries (the shapes of objects) of physical or simulated environments, the set of design parameter may provide a mesh. In this case, the scalar function may be applied as a function of the mesh itself. Indeed, a particularly useful scalar function in the case of 3d meshes is the volume, i.e. S({mesh})=volume, enclosed within the mesh. Given this scalar function, output variations maybe captured by the magnitude of the derivatives computed either analytically or numerically.

For a particular choice of such a scalar function, a next step may involve determining a metric from the scalar function. In certain embodiments, coordinates may be chosen such that the metric is diagonal. As described earlier, however, such a simplification is not required and generalization to other coordinate systems is contemplated as discussed above with respect to PCA.

The metric derived from the scalar function should capture the variations in the scalar function. In certain embodiments, the metric may coarsely capture the variations. To be more precise, if the scalar function varies significantly around a particular point in the parameter space, the metric value and correspondingly the distance at that point in parameter space should be large. In certain embodiments, the metric may finely capture the variations. Another consideration when designing this scalar function is the symmetry of the underlying parameter space—points of enhanced symmetry may be identified and weighted more heavily by the function, as they may correspond to regions with more interesting behavior, where more information can be obtained.

As described herein, a larger distance in the parameter space should lead to a larger sampling of that region. Given that a metric is generally positive definite, one technique is to define the metric components to be the absolute magnitude of the derivatives of the scalar function. For example, at a point p E P in parameter space a metric may be given by:

$$g = ( \begin{matrix}\vert \frac{\partial S}{\partial {p}_{1}} \vert & 0 & … & 0 \\ 0 & \vert \frac{\partial S}{\partial {p}_{2}} \vert & … & 0 \\ ⋮ & ⋮ & ⋱ & ⋮ \\ 0 & 0 & … & \vert \frac{\partial S}{\partial {p}_{n}} \vert\end{matrix} ) \qquad ( 6 )$$

where: S is a scalar function;
and pₙ are coordinates on parameter space and p=(p₁; p₂; . . . pₙ).

For a constant metric, it is possible to compute the derivatives at a single point in the parameter space. In this case, the metric may be computed at the single baseline point by varying each parameter one at a time and computing the derivatives of S with respect to each parameter. In certain embodiments, it is also possible to compute a non-uniform metric over the parameter space by expanding this calculation to multiple points in parameter space.

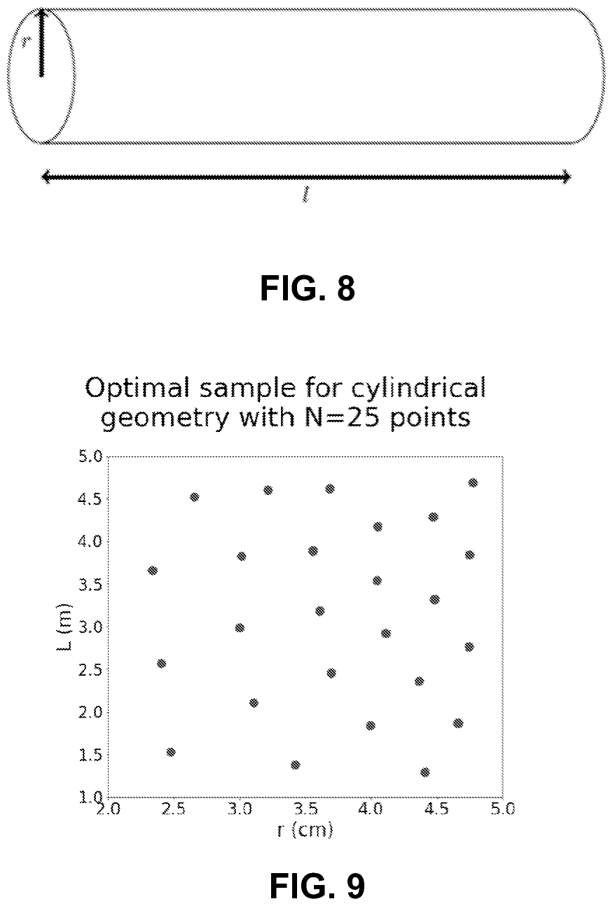

For a simple example of a computation of a constant metric in a 3d mesh, consider the example in FIG. 8 which depicts a simple cylinder where the design parameters are directed to the length l and radius r.

The volume of a cylinder is given by: V=πr²l. The derivatives are given by

$$\frac{\partial V}{\partial r} = 2 π rl , \frac{\partial V}{\partial l} = π {r}^{2} \qquad ( 7 )$$

where: V is the volume of a cylinder;
r is the radius of the cylinder;
and l is the length of the cylinder.

Generally, the larger the variation in the volume the more that region in parameter space should be sampled. In the cylinder example, a metric in the {r, l} coordinate space may be given by:

$$g = ( \begin{matrix}\vert \frac{\partial V}{\partial r} \vert & 0 \\ 0 & \vert \frac{\partial V}{\partial l} \vert\end{matrix} ) = ( \begin{matrix}2 π rl & 0 \\ 0 & π {r}^{2}\end{matrix} ) \qquad ( 8 )$$

where: V is the volume of a cylinder;
r is the radius of the cylinder;
and l is the length of the cylinder.

In this example, the absolute values of the derivatives is used because the metric computes the distance and is positive definite.

The reference parameter point plots computed for the above exemplary cylinder metric are shown in FIG. 9, where N=25. It can be seen in FIG. 9 that as both r and l increase the sample points get closer together. This is the region where the variation in the volume is the largest and hence more sampled by the algorithm.

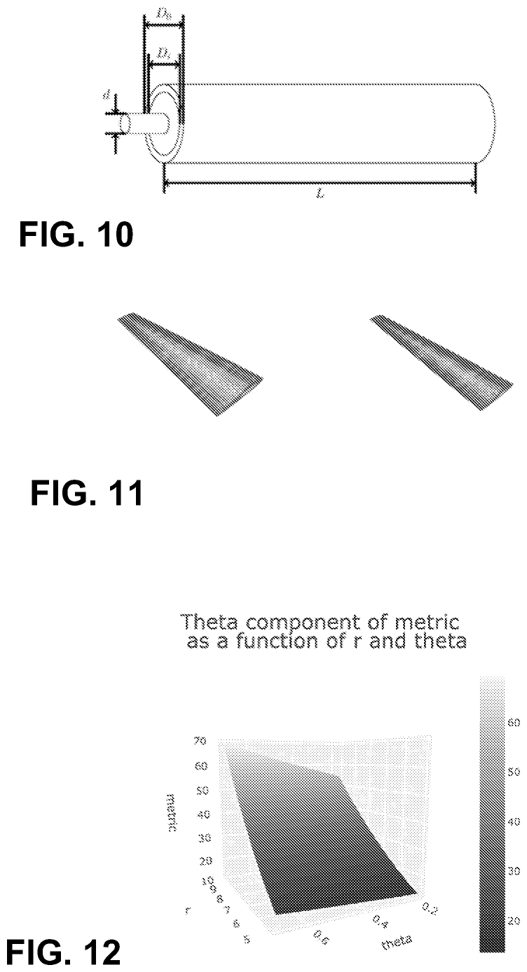

The simple cylinder example can be extended to illustrate the determination of a correlation metric and sampling of a design directed to a coaxial cable. A coaxial cable as illustrated in FIG. 10 includes an inner conductor surrounded by a concentric conducting shield, with the two separated by a dielectric insulating material. FIG. 10 depicts a cross section of a coaxial cable where the length of the cable is L, the diameter of the inner conductor is d and the inside and outside diameters of the conducting shield are Dᵢ and Dₒ.

Various electrical parameters like the capacitance, inductance, characteristic impedance and cutoff frequency depend on design parameters of the cable and the properties of the insulating material like the dielectric constant and the magnetic permeability.

An exemplary metric on the design parameter space containing the length L and the three diameters d, Dᵢ and Dₒ may be computed. In this example, for simplicity, the types of materials of the two conductors and the insulator will not form part of the metric but may be part of the design parameter space. However, it is still possible to differentiate between each of the materials in the coaxial cable. This may entail calculating the volume of each element separately and tracking how each of them varies as the design parameters are changed.

Continuing with this example, let V_{ic}, Vᵢₙₛ, and V_{oc} be the volumes of the inner conductor, insulator and outer conductor:

$${V}^{ic} = \frac{π {d}^{2} L}{4} , {V}^{ins} = \frac{π L}{4} ( {D}_{i}^{2} - {d}^{2} ) , {V}^{oc} = \frac{π L}{4} ( {D}_{o}^{2} - {D}_{i}^{2} ) \qquad ( 9 )$$

where: d is the diameter of the coaxial cable inner conductor;
Dᵢ is an inner diameter of the coaxial cable;
Dₒ is the outer diameter of the coaxial cable;
and L is the length of the coaxial cable.

The metrics for each material may then be calculated separately and added up to give the total metric. The metric for the inner conductor g^{ic} in the {L, d, Di, Do} coordinate system is given by:

$${g}^{ic} = ( \begin{matrix}\vert \frac{\partial {V}_{ic}}{\partial L} \vert & 0 & 0 & 0 \\ 0 & \vert \frac{\partial {V}_{ic}}{\partial d} \vert & 0 & 0 \\ 0 & 0 & \vert \frac{\partial {V}_{ic}}{\partial {D}_{i}} \vert & 0 \\ 0 & 0 & 0 & \vert \frac{\partial {V}_{ic}}{\partial {D}_{o}} \vert\end{matrix} ) = ( \begin{matrix}\frac{π {d}^{2}}{4} & 0 & 0 & 0 \\ 0 & \frac{π dL}{2} & 0 & 0 \\ 0 & 0 & 0 & 0 \\ 0 & 0 & 0 & 0\end{matrix} ) \qquad ( 10 )$$

where: V^{ic} is the volume of the inner conductor of the coaxial cable;
d is the diameter of the coaxial cable inner conductor;
Dᵢ is an inner diameter of the coaxial cable;
Dₒ is the outer diameter of the coaxial cable;
and L is the length of the coaxial cable.

Similarly, the metrics for the insulator gins and outer conductor goc are given by:

$${g}^{ins} = ( \begin{matrix}\frac{π ( {D}_{i}^{2} - {d}^{2} )}{4} & 0 & 0 & 0 \\ 0 & \frac{π dL}{2} & 0 & 0 \\ 0 & 0 & \frac{π {D}_{i} L}{2} & 0 \\ 0 & 0 & 0 & 0\end{matrix} ) , \\ {g}^{oc} = ( \begin{matrix}\frac{π ( {D}_{o}^{2} - {D}_{i}^{2} )}{4} & 0 & 0 & 0 \\ 0 & 0 & 0 & 0 \\ 0 & 0 & \frac{π {D}_{i} L}{2} & 0 \\ 0 & 0 & 0 & \frac{π {D}_{o} L}{2}\end{matrix} ) \qquad ( 11 )$$

where: d is the diameter of the coaxial cable inner conductor;
Dᵢ is an inner diameter of the coaxial cable;
Dₒ is the outer diameter of the coaxial cable;
and L is the length of the coaxial cable.

For simplicity, it may be assumed that all materials are equally weighted (e.g., λ^{ic}=λ^{ins}=λ^{oc}=1). As discussed in more detail below however, with additional domain knowledge pertaining to how each material might affect the output of the physical system (e.g., via computer model or physical model), these weights may be adjusted. Adding all the metrics for the equally weighted materials then gives:

$$g = ( \begin{matrix}\frac{π {D}_{o}^{2}}{4} & 0 & 0 & 0 \\ 0 & π dL & 0 & 0 \\ 0 & 0 & π {D}_{i} L & 0 \\ 0 & 0 & 0 & \frac{π {D}_{o} L}{2}\end{matrix} ) \qquad ( 12 )$$

where: d is the diameter of the coaxial cable inner conductor;
Dᵢ is an inner diameter of the coaxial cable;
Dₒ is the outer diameter of the coaxial cable;
and L is the length of the coaxial cable.

The design of cylindrical objects (e.g., a coaxial cable) is a case where there exists a simple analytical formula for the volume, which may be used to compute the derivatives with respect to each of the design parameters. In many practical situations, this is not feasible as the geometric dependence of each design parameter on each material can become difficult to track. In such cases, the derivatives of the scalar function may be calculated numerically. Given the mesh for each set of design parameters the volumetric difference can be computed using open source python packages such as pyvista. See C. Bane Sullivan and Alexander Kaszynski. PyVista: 3d plotting and mesh analysis through a streamlined interface for the visualization toolkit (VTK). Journal of Open Source Software, 4(37):1450, may 2019.

In certain embodiments, e.g., for more complicated systems, prior distributions may be obtained by using non-constant metrics that are parameter-dependent. An efficient way to incorporate parameter-dependent metrics may be to repeat the process discussed above at a plurality points in parameter space, and interpolating the metric throughout the remainder of parameter space. The plurality of points for a non-constant metric may be sampled by a random search, grid search, or using an initial constant form of the metric as described herein.

Exemplary techniques for determining correlation metrics for more complicated volumes are disclosed. Consider another example of optimizing an airplane wing's efficiency and aerodynamics. In the case of an airplane wing, the relationship between the design parameters and the volume is more complicated than that of a cylinder. FIG. 11 depicts an effect of changing a single design parameter associated with the width and curvature of the wing.

Here, the mesh difference and volume may be computed using known tools such as pyvista's Boolean operations and volumetric analysis. For these more complicated shapes, dividing the volumetric difference by the change in the parameter may provide an approximation for the derivative of the volume with respect to that volume. The correlation metric may then be computed numerically as before and optimization performed as discussed herein.

As an example, consider a two-dimensional subset of the full set of parameters for an airplane wing—the radius of curvature of the thicker part of the wing and the angle of the thinner part. FIG. 12 displays the theta component of the metric as a function of these two parameters.

The above discussion has focused primarily on geometric parameters in the determination of scalar functions and their associated correlation metrics. However, scalar functions and correlation metrics may be determined based on non-geometric parameters both continuous and non-continuous/discrete. For example, parameters for boundary conditions of the design or free parameters like the viscosity of a fluid in a CFD simulation may be used for the determination of scalar functions and correlation metrics. In certain embodiments, these parameters may be appropriately parameterized and incorporated into scalar functions described above.

For discrete or categorical variables, a generalization of the above techniques may be employed. To clarify, consider an example where a categorical variable may be the material used in the design of a circuit (e.g., a coaxial cable as discussed above). In certain embodiments, a scalar function and associated correlation metric may capture the variation of the geometric parameters with respect to the parameters representing the different materials used. For example, metrics may be computed separately for each material in the design and the full metric may be a weighted sum of the metric for each material. An example of such a technique follows from the equations below:

$${g}^{tot} = {\sum }_{i} {λ}^{( i )} {g}^{( i )} \qquad ( 13 )$$

where: i is an index for the material;
g is the metric;
and λᵢ are the relative weights associated with each material.

A more detailed example is described below. Further, other discrete or categorical variables may be incorporated in the same manner as follows:

$${g}^{tot} = {\sum }_{i , j , …} {λ}^{( {i}_{1 ,} {i}_{2 ,} … {i}_{m} )} {g}^{( {i}_{1 ,} {i}_{2 ,} … {i}_{m} )} \qquad ( 14 )$$

where: i is an index for the categorical features,
g⁽ⁱ^{₁}^{, i}^{₂}^{, . . . i}^{ₘ}⁾ is the metric for each feature,
and λᵢ are the relative weights associated with each feature.

To summarize, variations in geometry of a physical system may be used as a proxy for capturing the variation in the actual outputs of that system. Particular changes in the geometry might impact the output more than other changes. Using a scalar difference function is an efficient technique for determining sample reference points in the parameter space prior to performing a simulation. After performing simulations, this same framework allows for re-sampling of the parameter space by updating the metric on the parameter space. The procedure would be substantially the same but now the metric elements are directly given by the derivatives of the output. Once a metric for the parameter space is determined, optimization may be performed numerically using the framework described herein.

At step 630, one or more loss functions may be determined. In certain embodiments, it is preferable to maximize the distance between a set of N points in the d-dimensional parameter space, as measured by a metric, g, which may be determined as discussed with respect to step 620. As discussed above with respect to step 610, N and d may be part of a received parameter space definition.

In certain embodiments, a loss function may be computed by aggregating pairwise distances over a set of N points. In certain embodiments, a hyper-parameter, p is introduced and the technique maximizes to the L^{P} norm of the set of pairwise distances of a set X of N samples (here p>0):

$${ℓ}_{p} ( X ) = {( {\sum }_{x , y ∈ X} {d ( x , y )}^{p} )}^{1 / p} \qquad ( 15 )$$

where: X is the set of parameter values;
x is a point in parameter space;
y is a point in parameter space;
p is the norm degree;
and d is the distance function on parameter space.

Generally, one goal may be to determine a set of reference points X of size N which maximizes [symbol] ₚ (X) for a chosen p. In certain embodiments, where only the maximal value is desired it is not necessary to take the pth root of the above sum because x^{1/p} is a monotonically increasing function for p>0. A limiting case of this is the L^{∞} norm, which is equivalent to:

[symbol]

ₚ(X)=max d(x,y)

x,y∈X (16)

where: X is the set of parameter values;

x is a point in parameter space;

y is a point in parameter space;

and d is the distance function on parameter space.

In other words, an “objective function” Oₚ(X) may be:

Oₚ(X)= [symbol] ₚ(X) (17)

where: X is the set of parameter values.

As discussed above, Oₚ(X) may be maximized to determine a set of reference points. Equivalently −Oₚ(X) may considered a “loss function.” In certain embodiments, an objective function may be:

Oₘₐₓᵢₘᵢₙ(X)=Min_{x,y∈X}d(x,y) (18)

where: X is the set of parameter values;
x is a point in parameter space;
y is a point in parameter space;
and d is the distance function on parameter space.

In other words, in certain embodiments, a suitable objective function may seek to maximize the minimum distance between reference points in the sample. This approach may be contrasted with the case of Oₚ, where p=∞. In this latter case, maximizing the maximum distance between reference points, may be a less useful technique.

Generally, these objective functions have the effect of pushing the points to be as far apart as possible, as measured by the underlying metric. Accordingly, the choice of objective function may be left up to the skilled designer. It should be noted, however, that a “maximin” type of objective function may be efficiently implemented as part of a gradient descent algorithm.

In certain embodiments, a distance function, d(x, y), is computed from a metric, g. If g is constant, the following equation may apply:

$${d ( x , y )}^{2} = {\sum }_{i , j} {{g}_{i , j} ( x - y )}_{i} {( x - y )}_{j} \qquad ( 19 )$$

where: g is the metric;
i is an index on parameter space;
j is an index on parameter space;
x is a point on parameter space;
and y is a point on parameter space.

ever, several approaches may be used. A mathematically precise notion of distance may be used to define the geodesic distance of a path connecting x and y, and take the infimum of this distance over all possible paths. Such an approach is generally computationally expensive. Accordingly, it is possible to use an approximation, such as the following for x reasonably close to y:

$${d ( x , y )}^{2} = {\sum }_{i , j} {g}_{i , j} ( \frac{1}{2} ( x + y ) ) {( x - y )}_{i} {( x - y )}_{j} \qquad ( 20 )$$

where: g is the metric;
i is an index on parameter space;
j is an index on parameter space;
x is a point on parameter space;
and y is a point on parameter space.

If more accuracy is desired, however, the path from x to y may be approximated by several line segments and the metric evaluated at one or more points (e.g., the endpoints) of these intermediate segments.

As discussed above, a parameter space definition may include one or more constraints. Accordingly, a loss function may be modified to account for constraints (e.g., bounds and/or other constraints). In certain embodiments, to account for one or more bounds, a loss function, [symbol] ₚ(X), may be modified to include a distance to the boundary of parameter space. In the presence of bounds on parameters and linear constraints, the restrictions may be summarized as a set of linear inequalities:

a_{α}ⁱxᵢ+b_{α}>0,α=1, . . . ,n (21)

where: i is an index on parameter space;
α is an index on the set of constraints;
a is the linear term in the constraint relation;
b is the constant term in the constraint relation;
x is a coordinate on parameter space;
and n is the total number of bounds and constraints.
   In certain embodiments, to account for constraints, the distance of each point to each of the hyperplanes where the above inequalities are saturated may be included in one or more loss functions. In certain embodiments, the distance of a point to a hyperplane, H, defined by an equation aⁱxᵢ+b=0, in a constant metric, g, may be found using a Lagrange multiplier, and may be given by:

$$d ( x , H ) = \frac{\vert {a}^{i} {x}_{i} + b \vert}{‖ a ‖} \qquad ( 22 )$$

where: i is an index on parameter space;
a is the linear term in the constraint relation;
b is the constant term in the constraint relation;
x is a coordinate on parameter space;
and n is the total number of bounds and constraints.
   and where

∥a∥²=g_{i,j}⁻¹aⁱa^{j} (23)

where: i is an index on parameter space;
j is an index on parameter space;
a is the linear term in the constraint relation;
and g is the metric.

The sum over all points and all hyperplanes, Hₐ, may then be included in a loss function as follows:

$${{ℓ}_{p} ( X )}^{p} = {\sum }_{x , y} d ( x , y ) + 2 * {\sum }_{x , α} d ( x , {H}_{α} ) \qquad ( 24 )$$

where: x is a point on parameter space;
y is a point on parameter space;
d is the distance function;
α is an index over constraint hyperplanes;
and H is a constraint hyperplane.

A factor of two arises in the above equation because essentially the radius of a ball that can fit around each point is being maximized. For the distance to the boundary (a bound), only one factor of this radius enters into the distance, while for two points, the radius of both balls enters, giving an extra relative factor of two.

For non-constant metrics, in certain embodiments, the metric at the point, x, may be approximated similar to the above. For non-constant metrics, in certain embodiments, the metric along intermediate points between x and the constraint surface may be approximated.

For non-linear constraints, the constraint surface may be approximated by locally linear constraints. However, this may require more careful consideration in the case of non-convex constraints.

At step 640, one or more sets of reference points may be computed. In certain embodiments, reference points may be determined by maximizing the average distance between points. In certain embodiments, reference points may be determined by maximizing min_{x,y} dist(x,y). In certain embodiments, one or more sets of reference points may be computed using a loss function, such as a loss function determined with respect to step 630.

Generally, numerical solutions for determining reference points may be found using built-in minimization algorithms in libraries such as Scipy (see Pauli Virtanen, Ralf Gommers, Travis E. Oliphant, Matt Haberland, Tyler Reddy, David Cournapeau, Evgeni Burovski, Pearu Peterson, Warren Weckesser, Jonathan Bright, Stefan J. van der Walt, Matthew Brett, Joshua Wilson, K. Jarrod Millman, Nikolay Mayorov, Andrew R. J. Nelson, Eric Jones, Robert Kern, Eric Larson, C J Carey, Ihan Polat, Yu Feng, Eric W. Moore, Jake Vander Plas, Denis Laxalde, Josef Perktold, Robert Cimrman, Ian Henriksen, E. A. Quintero, Charles R Harris, Anne M. Archibald, Antonio H. Ribeiro, Fabian Pedregosa, Paul van Mulbregt, and SciPy 1.0: Contributors. Scipy 1.0: Fundamental algorithms for scientific computing in python. Nature Methods, 2020), gradient descent, and/or using libraries such as Tensor-flow (see Martin Abadi, Ashish Agarwal, Paul Barham, Eugene Brevdo, Zhifeng Chen, Craig Citro, Greg S. Corrado, Andy Davis, Jeffrey Dean, Matthieu Devin, Sanjay Ghemawat, Ian Goodfellow, Andrew Harp, Geoffrey Irving, Michael Isard, Yangqing Jia, Rafal Jozefowicz, Lukasz Kaiser, Manjunath Kudlur, Josh Levenberg, Dan Mane, Rajat Monga, Sherry Moore, Derek Murray, Chris Olah, Mike Schuster, Jonathon Shlens, Benoit Steiner, Ilya Sutskever, Kunal Talwar, Paul Tucker, Vincent Vanhoucke, Vijay Vasude-van, Fernanda Viégas, Oriol Vinyals, Pete Warden, Martin Wattenberg, Martin Wicke, Yuan Yu, and Xiaoqiang Zheng. TensorFlow: Large-scale machine learning on heterogeneous systems, 2015. Software available from tensorflow.org). Some efficient approaches to these kinds of computations are discussed in Thomas Schlömer, Daniel Heck, and Oliver Deussen. Farthest-point optimized point sets with maximized minimum distance. In Proceedings of the ACM SIGGRAPH Symposium on High Performance Graphics, HPG '11, page 135-142, New York, N.Y., USA, 2011. Association for Computing Machinery.

Optimization procedures also may be modified to implement the constraints on the coordinates of the sample points in various open-source optimization libraries, such as Scipy.

Particular Embodiments for Reference Point Determination
1. For a sample of N points in a D-dimensional space, take the set of N D-dimensional vectors in the provided range with maximum average distance between points.

In this example, “distance” is the naive Euclidean distance as measured in the parameter space. FIG. 12 illustrates N points in 2d unit box chosen to be as far as possible from each other, for N from 4 to 12.
2. Pick a set of N points such that the distance between them is as large as possible, but the set of non-sampled points close to them is as large as possible.

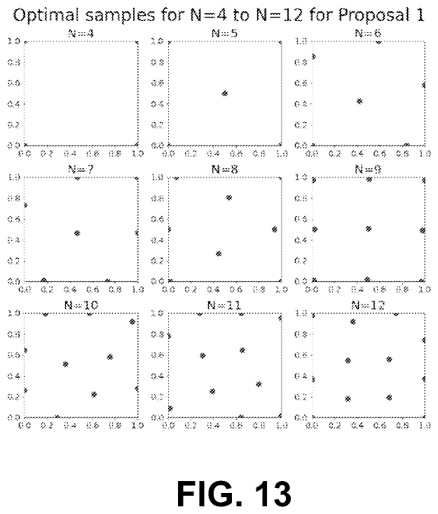

Like the first example, “distance” is the naive Euclidean distance as measured in the parameter space. The second constraint may be satisfied by making sure the points are also as far as possible from the boundary of the parameter space. Computing a loss function that accounts for the boundary in this manner is discussed above with respect to step 640 of FIG. 6. FIG. 13 illustrates N points in 2d unit box chosen to be as far as possible from each other and from the boundary, for N from 4 to 12.

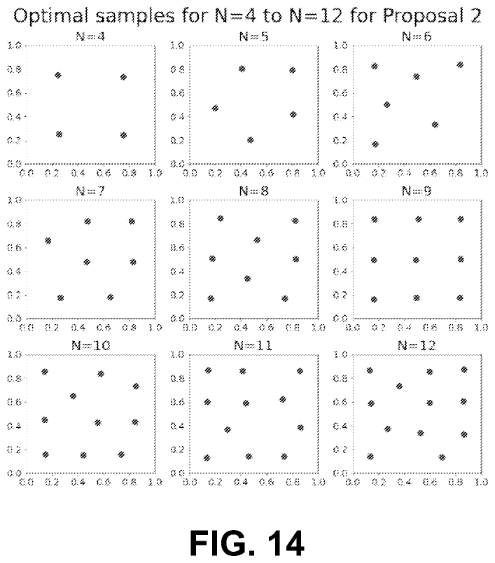

FIG. 14 illustrates an optimal sampling prescription and a random sampling of points for N=15 points. It can be seen that the random sampling both has clusters of close points, leading to redundancy, and regions without many points, leading to incompleteness. However, an optimal sampling prescription avoids both of these problems.

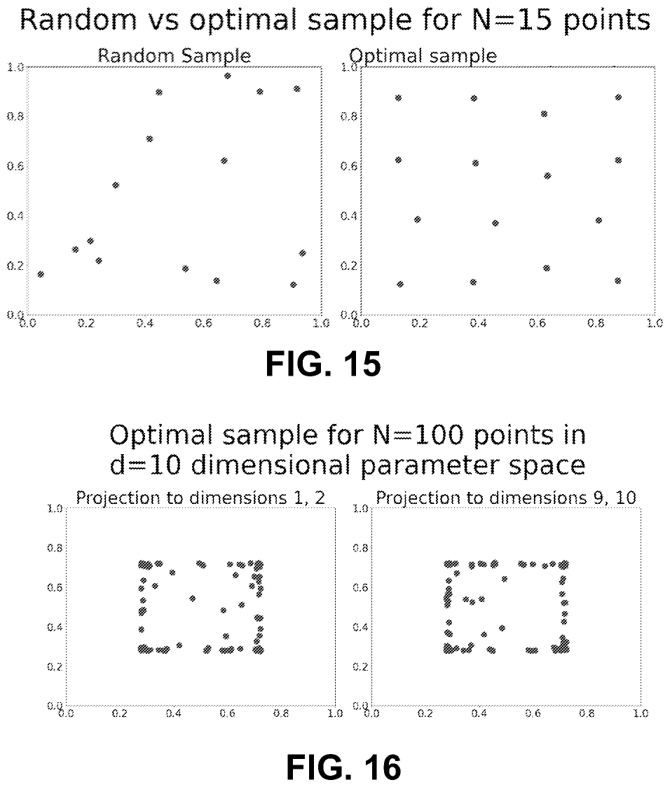

For high dimensions, it is more difficult to visualize the samples. However, it is possible inspect projections onto two-dimensional subspaces. FIG. 15 illustrates two such projections for a d=10 dimensional parameter space sampling of N=100 points. It can be seen that the points seem to be clustered closer to the center of the parameter space. This is an artifact of the projection throwing away information about the separation of the points in many of the dimensions, making the points, which look very close in this plot, actually spread out from each other in an balanced way with their distance from the boundaries. For example, in d dimensions, the optimal sampling of N=2 points is to take them to lie at (x, x, . . . , x) and (1−x, 1−x, . . . , 1−x) where

$$x - \frac{1}{2} \cdot \frac{\sqrt{d}}{1 + \sqrt{d}}$$

Namely, this guarantees the 2 1+ points are as far from each other as from the boundary. However, note that on a 2d projection, as d becomes large they would appear to both be very close to the center at

$$( \frac{1}{2} , \frac{1}{2} ) .$$

3. Pick a set of N points such that the distance between them is as large as possible, but the set of non-sampled points close to them is as large as possible with an additional constraint.

FIG. 16 illustrates an example of N points in 2d unit box chosen to be as far as possible from each other and from the boundary, with a constraint that y>x, for N from 4 to 12. Computing a loss function that accounts for the boundary and an additional constraint in this manner is discussed above with respect to step 640 of FIG. 6.
4. Pick a set of N points such that the distance between them, and the distance to the boundary, is as large as possible, as measured by a metric, gᵢⱼ

Unlike the first two examples, the “distance” here is measured by a metric, gᵢⱼ. Metric gᵢⱼ, as discussed above, is chosen to reflect domain and other prior knowledge about the simulation problem. Computing a loss function that accounts for the boundary and a metric is discussed above with respect to step 640 of FIG. 6.

In this example, the electrical resistance through a piece of wire is being simulated or measured. The parameters here are the length of the wire, L, and the cross-sectional area, A. For a simple resistor, resistance is proportional to L/A. While this is unlikely to be the exact behavior found by experiment or a detailed computer simulation, this defines an adequate set of prior assumptions, and allows for a correlation metric to be determined.

For example, if lengths from L=1 mm to L=2 mm, and areas from A=10 mm² to A=12 mm² are being tested, there should be a larger variation in resistance over the range of length parameter than over that of the area parameter. Accordingly, a metric should assign a larger weighting to the range of lengths.

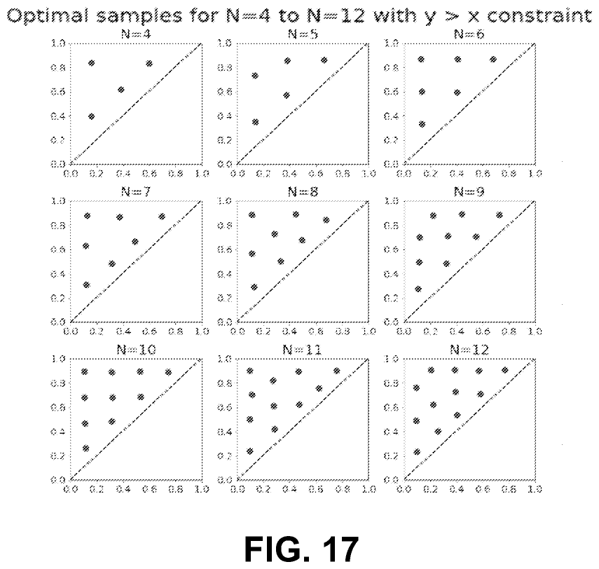

FIG. 17 illustrates an example of 15 reference points in a 2d box chosen to be as far as possible from each other and from the boundary and illustrating the natural units of area and length. This leads to an unbalanced sampling of the two parameters.

Rescaling the coordinates to the unit box, [0,1]×[0,1], correspondingly shifts the metric to:

$$g = ( \begin{matrix}1 & 0 \\ 0 & 25\end{matrix} ) \qquad ( 25 )$$

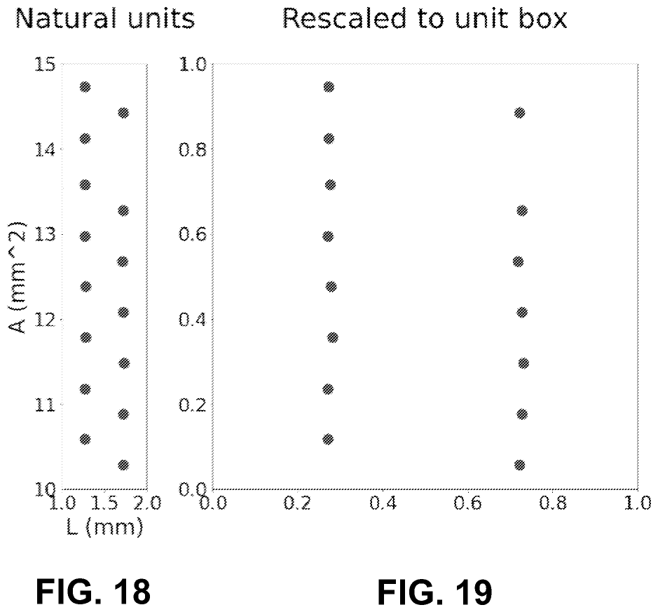

With this metric, the points are sampled more densely along the y-axis than along the x-axis. FIG. 18 Illustrates an example of 15 reference points in 2d unit box chosen to be as far as possible from each other and from the boundary, and with the metric for the y direction being 5 times that for the x direction.

Here, sampling more values along the y direction than the x direction leads to more information gain as the variance in this direction is higher. Also, notice from FIG. 19 that in the natural units, the points appear equally spaced, while after rescaling to the unit box, the non-uniform metric imposes a larger spacing in the x-direction. FIG. 19 illustrates an example of N points in a 2d unit box chosen to be as far as possible from each other and from the boundary, and with the metric for the y direction being 5 times that for the x direction, for N from 4 to 12
5. Pick a set of N points such that the distance between them, and the distance to the boundary, is as large as possible, as measured by non-constant metric

To illustrate how a spatially varying metric may affect the optimal sampling, consider the case of a 2d parameter space, with parameter x and y, and metric:

$$g = ( \begin{matrix}1 + {( 4 y )}^{2} & 0 \\ 0 & 1 + {( 4 y )}^{2}\end{matrix} ) \qquad ( 26 )$$

where: y is one of the parameters on the 2d parameter space.

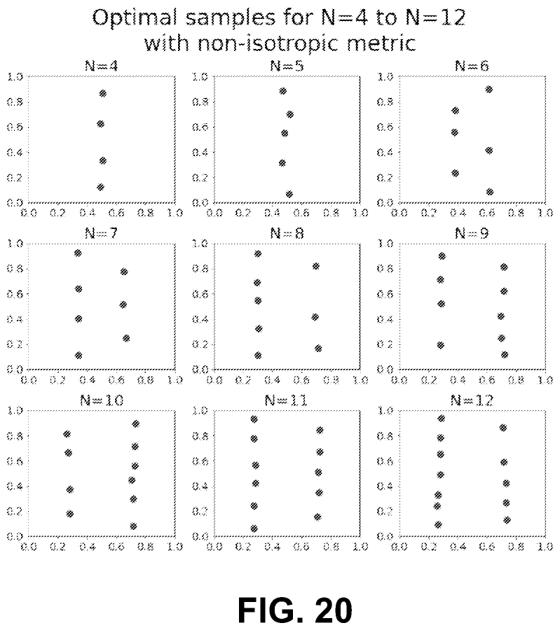

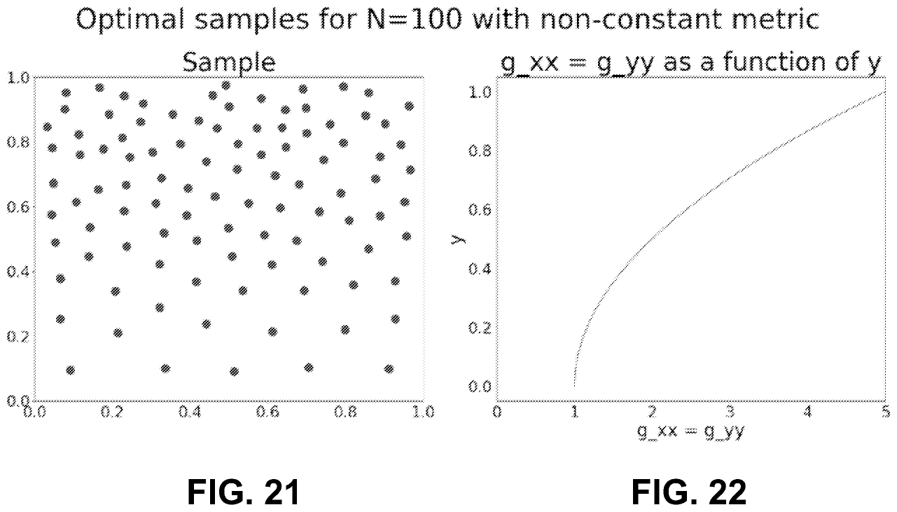

FIG. 20 on the left illustrates an optimal sampling for N=100 points. FIG. 21 on the right illustrates the metric. Note that a higher density of points is sampled in the region of larger y, where the metric is larger and so the correlations between nearby points are decaying more quickly.

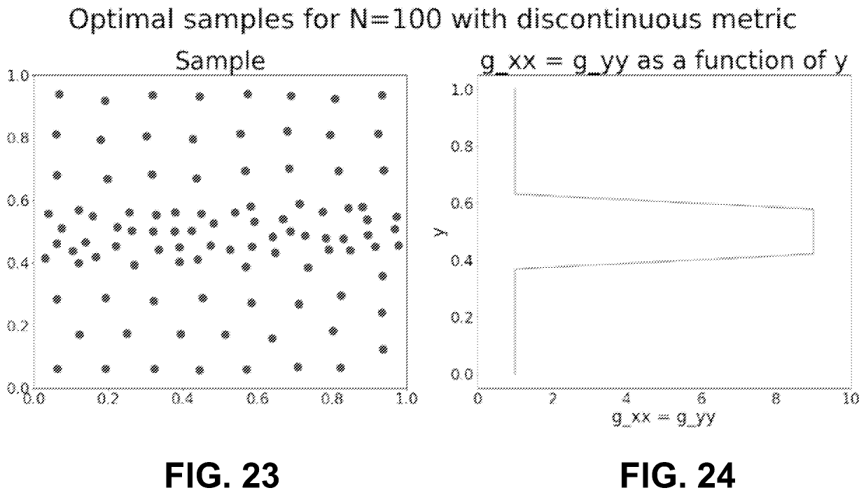

Metrics may also have singularities and/or discontinuities. This can happen, for example, if changing a parameter beyond a certain value qualitatively changes the system under consideration. FIG. 23 on the right illustrates a metric that has a rapid increase around x=0.5. FIG. 22 on the left illustrates an optimal sampling for N=100 points with a metric that rapidly increases near x=0.5.

FIG. 24 illustrates a generic, real world situation where the metric is smoothly varying in the x direction and has a discontinuity in the y direction. FIG. 24 illustrates an optimal sampling for N=100 points with a metric that rapidly increases near x=0.5.

Foundations of the Above Techniques for Reference Point Determination

Above, a progression of techniques for reference point determination are discussed. The first assumes a Euclidean distance is used for a loss function, the second builds upon this by accounting for a boundary on the range of parameters, while the fourth adopts a robust correlation metric in place of the Euclidian distance for use in the loss function.

The progression is the result several assumptions and mathematical simplifications, which will now be discussed. One assumption is that the outputs are samples from a multivariate normal distribution. This approach has close connections to the notion of a “gaussian process,” which is commonly used in Bayesian data analysis. Here, for simplicity a single output is considered, even though the true output will typically be multi-dimensional. In this case, the variables of the Gaussian would be the outputs for each point in parameter space. Since there are uncountably many of these, discretizing them and calling these variables x₁, . . . , x_{M}. may provide a better understanding.

For example, if the parameter space is d-dimensional, and m grid points are taken for each dimension, there would be a total of m^{d} discrete parameter choices, and so M=m^{d} variables, xᵢ. The distribution will depend on a choice of means, μᵢ for each variable and a correlation matrix, Σ_{i,j}, and is denoted [symbol] (μ, Σ).

Suppose x₁ is measured and the value found to be xᵢ*. If x₂, . . . , x_{M} were completely uncorrelated from x₁ (i.e., all entries Σ_{i,j}, for i∈{2, . . . , M} were 0), there would be no information gain, as described above. More generally, let us write:

$$\sum = ( \begin{matrix}σ & {γ}_{i} \\ {γ}_{i}^{T} & {\hat{\sum }}_{i , j}\end{matrix} ) , μ = ( \begin{matrix}{μ}_{1} \\ {\hat{μ}}_{i}\end{matrix} ) \qquad ( 27 )$$

where: i is an index on parameter space greater than 1;
j is an index on parameter space greater than 1;
σ is the covariance of the gaussian distribution for the first component on parameter space;
γ is the cross-covariance of the gaussian distribution between coordinate 1 and coordinates {2, . . . , M};
M is the dimension of parameter space;
and μ is the mean of the gaussian distribution.

Where \hat{Σ} and \hat{μ} are the means and covariance for the variables x₂, . . . , x_{M}. Then the distribution for x₂, . . . , x_{M}. gets updated to a new normal distribution with:

$${\hat{μ}}_{i} \to {\hat{μ}}_{i} + {γ}_{i} \frac{{x}_{1}^{*} - {μ}_{1}}{{σ}_{1}} \qquad ( 28 )$$

where: i is is an index on parameter space greater than 1;
σ is the covariance of the gaussian distribution for the first component on parameter space;
γ is the cross-covariance of the gaussian distribution between coordinate 1 and coordinates {2, . . . , M};
x₁* is the transformed coordinate on parameter space;
μ is the mean of the gaussian distribution;
and \hat{μ}ᵢ is the mean of the ith coordinate.

$${\hat{\sum }}_{i , j} \to {\hat{\sum }}_{i , j} - \frac{{γ}_{i} {γ}_{j}}{{σ}_{1}} \qquad ( 29 )$$

where: i is is an index on parameter space greater than 1;
j is is an index on parameter space greater than 1;
σ is the covariance of the gaussian distribution for the first component on parameter space;
γ is the cross-covariance of the gaussian distribution between coordinate 1 and coordinates {2, . . . , M};
and \hat{Σ} is the transformed covariance matrix of the gaussian distribution.

It can be seen that this measurement updates the means/correlations of the other parameters which are larger for a) larger correlations with x₁, b) larger deviation of the measured value of x₁ from its expected value, and c) smaller variance of x₁.

The information gain from this measurement may be computed as measured by the Kullback—Leibler divergence. For two n-variate normal distributions p and q, the KL divergence may be computed as:

$${D}_{KL} ( P \vert Q ) = \frac{1}{2} ( log ( \frac{det {\sum }_{Q}}{det {\sum }_{P}} ) - + {( {μ}_{P} - )}^{T} ( {μ}_{P} - ) + tr {\sum }_{P} ) \qquad ( 30 )$$

where: P is the prior probability distribution;
[symbol] is the posterior probability distribution;
[symbol] is the dimension of parameter space;
μ is the mean of the prior and posterior distributions;
and Σ is the covariance of the prior and posterior distributions.

This equation informs how much is learned when the measurement is made and pass from the prior distribution, Q, to the posterior distribution, P, after making a Bayesian update. Similar Bayesian considerations have been used previously for experimental design (see Kathryn Chaloner and Isabella Verdinelli. Bayesian Experimental Design: A Review. Statistical Science, 10(3):273-304, 1995).

Since before making the measurement it is not known what value will be obtained, the expected value of this information gain maybe computed. Using the expressions above and making a simplifying assumption that the change in \hat{Σ}_{i,j} is relatively small compared to \hat{Σ}_{i,j} the above expression simplifies to:

$$〈 {D}_{KL} ( P \vert Q ) 〉 \approx \frac{1}{2 {σ}_{1}} {γ}^{T} \hat{{\sum }^{- 1} γ} \qquad ( 31 )$$

where: P is the prior probability distribution;
[symbol] is the posterior probability distribution;
σ is the covariance of the gaussian distribution for the first component on parameter space;
γ is the cross-covariance of the gaussian distribution between coordinate 1 and coordinates {2, . . . , M};
and Σ is the covariance matrix for coordinates {2, . . . , M}.

More generally, suppose m points are sampled from a subset X of all possible points in parameter space. Let Y denote the remaining, unsampled points. Similar to above, the means and correlation matrix may be decomposed, as:

$$\sum = ( \begin{matrix}{\sum }_{XX} & {\sum }_{XY} \\ {\sum }_{YX} & {\sum }_{YY}\end{matrix} ) , μ = ( \begin{matrix}{μ}_{X} \\ {μ}_{Y}\end{matrix} )$$

where: X is a subset of parameter space;
Y is the complement of X;
μ is the mean of each subset;
and Σ is the covariance of each subset.

A similar calculation (33) for this general case gives the approximation:

[symbol]

D_{KL}(P|Q) [symbol] ≈½tr(Σ_{XX}⁻¹Σ_{XY}Σ_{YY}⁻¹Σ_{YX}) (33)

where: X is a subset of parameter space;
Y is the complement of X;
and Σ is the covariance of each subset.

This suggests that a set of variables should be measured such that a) there are small correlations among the set, b) there are small correlations among the remaining variables (but since these will be a much larger set, it may be assumed that this term is approximately constant) but c) there is a large correlation between the first variable and the remaining variables.

Next, another assumption is made on the structure of the correlation matrix, Σ. As mentioned above, the basic assumption is that points closer in parameter space should have a higher correlation. Specifically, it is assumed that the correlation between the outputs at points x and [symbol] in parameter space has the basic form:

corr( [symbol] ₓ, [symbol] _{y})=ƒ(d(x,y)) (34)

where: x is a point in parameter space;
y is a point in parameter space;
d(x,y) is the distance between the two points;
and ƒ: [symbol] _{>0→}R is a monotonically decreasing function of this distance.
   Techniques discussed above provide reasonable a priori hypotheses for these functions. For example, for the distance function, d(x,y) it may be based on Euclidean distance or based on physical considerations for the problem at hand. The decreasing function ƒ may have various forms, such as an exponential or power-law decay, but the specific form of this function will likely have little impact.

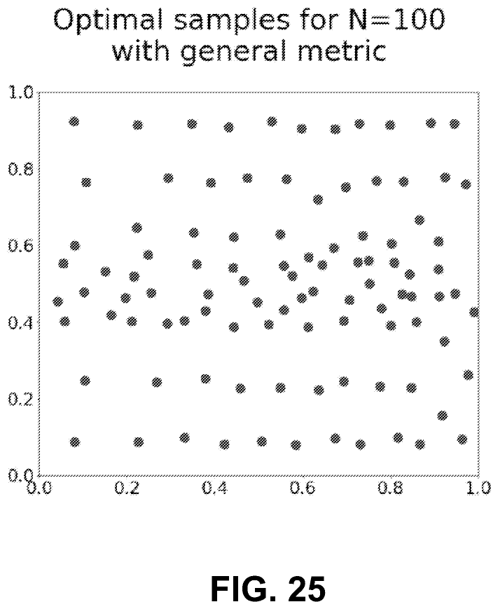

To visualize how the expected KL divergence gain in eq. (33) varies with the choice of sample point, consider the simple example of a single parameter valued in the unit interval [0, 1]. In the following numerical examples, ƒ(x)=e^{-x}, but similar results are obtained for other monotonically decreasing functions. If only a single point is allowed to be sampled from this interval, the expected KL divergence is shown in FIG. 25, which illustrates the expected gain in KL divergence for a single point sampled from the unit interval, [0, 1], as a function of position, x, along the interval.

It is seen that the maximum information gain is obtained by taking the point in the middle of the interval. This choice maximizes the exposure of the point to nearby unsampled points with maximal correlation.

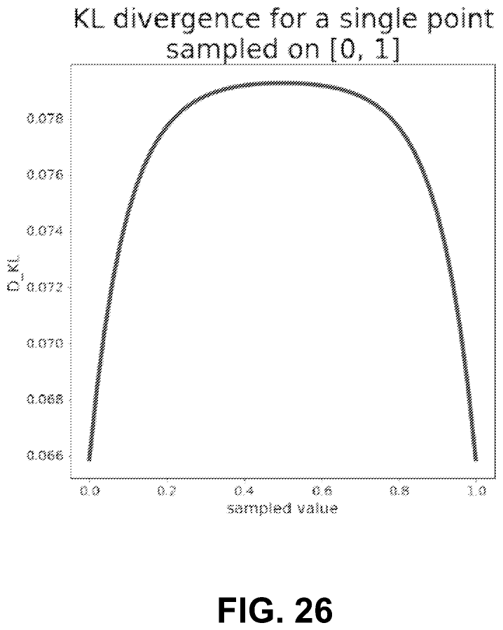

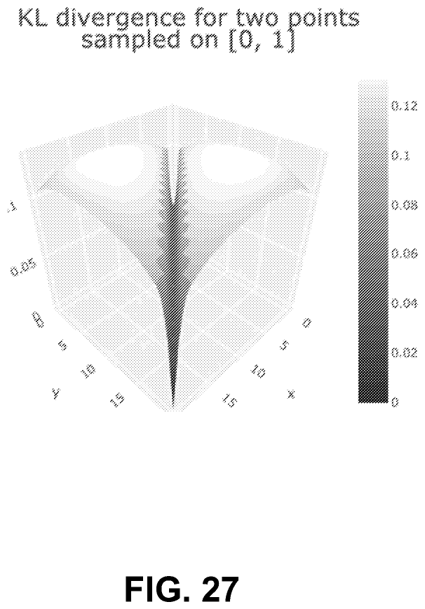

Next, suppose two points are sampled on the unit interval. The expected KL divergence in this situation is shown in FIG. 26 which illustrates the expected gain in KL divergence for two points sampled from the unit interval, [0,1], as a function of positions, x and y, along the interval. Here, it is desirable to balance the exposure of these points to nearby unsampled points, but also avoid redundancy from having the two points close together. The optimal choice here turns out to be to take one point at 0.25 and the other at 0.75. This maximizes the exposure of the set of sampled points to the unsampled points.

Maximizing the information gain in this manner, as compared to random sampling, results in, on average, a 7.0% increase in KL divergence in the case of a single point, and a 10.4% increase in the case of two points.

For more points and higher dimensional parameter spaces, it can quickly become expensive to compute the KL divergence for all possible sampling schemes. However, the considerations (maximizing the exposure of the set of sampled points to the unsampled points) above lead to embodiment, which account for a boundary on the range of parameters.

Recall eq. (33):

[symbol]

D_{KL}(P|Q) [symbol] ≈tr(Σ_{XX}⁻¹Σ_{XY}Σ_{YY}⁻¹Σ_{YX}) (35)

It is possible to form an estimate of the above with some basic assumptions on the correlations matrices. Namely, it may be assumed that for any two points x, y in parameter space, the correlation between them is given by:

$${\sum }_{x , y} = \{ \begin{matrix}v ( x ) & x = y \\ f ( d ( x , y ) ) & x \neq y\end{matrix} \qquad ( 36 )$$

where: x is a point in parameter space;
y is a point in parameter space;
d is the distance function on parameter space;
v is some function on parameter space valued in [symbol] _{>0};
and ƒ is some monotonically decreasing function which approaches zero for large distances.

To approximate eq. (33), a few more assumptions may be made. First, it may be assumed that a parameter value's self-correlation (variance) is much higher than its correlation with other parameter values. This means that the matrix is approximately diagonal. This leads to the following formula for its (approximate) inverse:

$${\sum }_{x , y}^{- 1} \approx \{ \begin{matrix}{v ( x )}^{- 1} & x = y \\ - \frac{1}{v ( x ) v ( y )} f ( d ( x , y ) ) & x \neq y\end{matrix} \qquad ( 37 )$$

where: x is a point in parameter space;
y is a point in parameter space;
d is the distance function on parameter space;
v is some function on parameter space valued in [symbol] _{>0};
and ƒ is some monotonically decreasing function which approaches zero for large distances.

With this assumption, the trace (tr) in eq. (33) can be written as:

$$〈 {D}_{KL} ( P \vert Q ) 〉 \approx {\sum }_{{x}_{1} , {x}_{2} , {y}_{1} , {y}_{2}} ( {v ( {x}_{1} )}^{- 1} {δ}_{{x}_{1} , {x}_{2}} - \frac{1}{v ( {x}_{1} ) v ( {x}_{2} )} f ( d ( {x}_{1} , {x}_{2} ) ) ) f ( d ( {x}_{2} , {y}_{1} ) ) \times ( {v ( {y}_{1} )}^{- 1} {δ}_{{y}_{1} , {y}_{2}} - \frac{1}{v ( {y}_{1} ) v ( {y}_{2} )} f ( d ( {y}_{1} , {y}_{2} ) ) ) f ( d ( {y}_{2} , {x}_{1} ) )$$

where: x is a point in parameter space;
y is a point in parameter space;
δ is the Kronecker delta function;
d is the distance function on parameter space;
v is some function on parameter space valued in [symbol] _{>0};
and ƒ is some monotonically decreasing function which approaches zero for large distances.
   and where:

$$A = {\sum }_{x , y} {v ( x )}^{- 1} {v ( y )}^{- 1} {f ( d ( x , y ) )}^{2} \\ B = - {\sum }_{{x}_{1} , {x}_{2} , y} {v ( {x}_{1} )}^{- 1} {v ( {x}_{2} )}^{- 1} {v ( y )}^{- 1} f ( d ( {x}_{1} , y ) ) f ( d ( {x}_{2} , y ) ) f ( d ( {x}_{1} , {x}_{2} ) ) \\ C = - {\sum }_{x , {y}_{1} , {y}_{2}} {v ( x )}^{- 1} {v ( {y}_{1} )}^{- 1} {v ( {y}_{2} )}^{- 1} f ( d ( x , {y}_{1} ) ) f ( d ( x , {y}_{2} ) ) f ( d ( {y}_{1} , {y}_{2} ) ) \qquad ( 39 )$$

where: x is a point in parameter space;
y is a point in parameter space;
d is the distance function on parameter space;
v is some function on parameter space valued in [symbol] _{>0};
and ƒ is some monotonically decreasing function which approaches zero for large distances.

Since it is assumed v(x)>>ƒ(d(x,y), the leading contribution will come from the A term. Accordingly, the summand here is maximized by taking x to have as many points in the Y set as close to it as possible. Explicitly, for the parameter space being a unit hypercube with f decreasing, it can be shown that this is maximized by taking x in the center of the hypercube.

In a more naïve approach, this may lead to taking all x at this point. However, such an approach ignores interactions between the x's, which come from the B and C terms. After including these terms, the expressions above can be re-written slightly as:

$$A + B + C = {\sum }_{x} F ( x ) + {\sum }_{{x}_{1} , {x}_{2}} G ( {x}_{1} , {x}_{2} ) \qquad ( 40 )$$

where F(x) is determined by A and C, and is given by:

$$F ( x ) = {v ( x )}^{- 1} ( {\sum }_{y} {v ( y )}^{- 1} {f ( d ( x , y ) )}^{2} - {\sum }_{{y}_{1} , {y}_{2}} {v ( {y}_{1} )}^{- 1} {v ( {y}_{2} )}^{- 1} f ( d ( x , {y}_{1} ) ) f ( d ( x , {y}_{2} ) ) f ( d ( {y}_{1} , {y}_{2} ) ) ) \qquad ( 41 )$$

and G(x₁, x₂) is determined by B, and is given by:

G(x₁,x₂)=−v(x₁)⁻¹v(x₂)⁻ƒ(d(x₁,x₂))Σ_{y}v(y)⁻¹ƒ(d(x₁,y))ƒ(d(x₂,y)) (42)

where x is a point in parameter space;
y is a point in parameter space;
d is the distance function on parameter space;
v is some function on parameter space valued in [symbol]
and ƒ is some monotonically decreasing function which approaches zero for large distances.

As introduced above, the first term, F(x), which is the leading contribution, tends to draw individual points towards the middle of the parameter space, where the average distance to unsampled points is as small as possible. The contribution from C represents a small correction to this, so qualitatively it is expected that this behavior is unchanged. The second term, G(x₁, x₂), represents the leading contribution to interactions between points. Due to its prefactor, it is largest when x₁ and x₂ are as far apart as possible. This justifies the assertion that the KL divergence is maximized by simultaneously taking the points to be a) reasonably deep in the interior of the parameter space, and b) as far as possible from each other.

Comparison of Techniques for Determining Reference Points

Improvements realized by employing non-trivial correlation metrics may be quantified by estimating the expected information gain (KL divergence). Here, three techniques for determining reference points will be compared: random sampling (RS), distance maximization with a trivial metric; and distance maximization using domain-knowledge-informed correlation metrics.

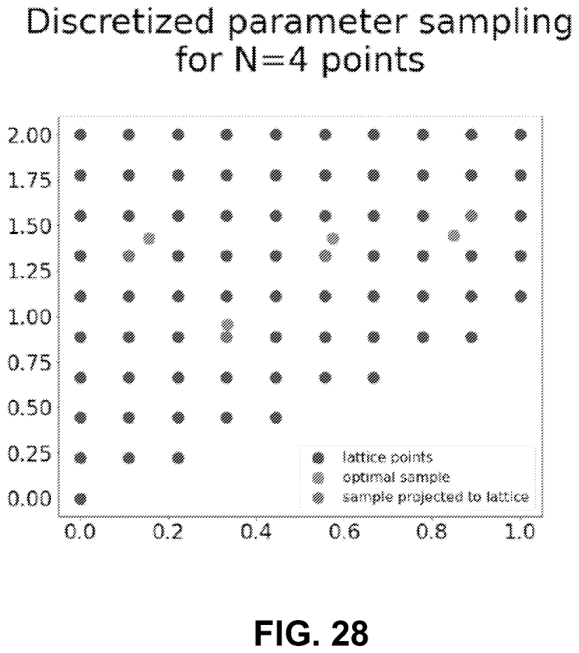

To compute the expected information gain, it may be convenient to discretize the parameter space into a number, Nlattice, of lattice points per dimension. This reduces the parameter space from an infinite to a finite set and allows numeric computation of the correlation matrix. Eq. (33) may be used to compute the KL divergence for a chosen set of sample points. The points of the sampling techniques may be projected on the nearest lattice point as illustrated in FIG. 28.

For this comparison, a generic sample design problem is considered with a non-square boundary, constraint inequality, and a non-isotropic metric, g=diag(25, 0). The results for these three techniques are shown in Table 1. The naïve distance maximization technique improves 8.6% over the random sampling technique. Distance maximization using domain-knowledge-informed correlation metrics, however, has almost double the improvement in information gain over naïve distance maximization with a 15.4% improvement.

This makes clear that plausible candidates used for domain-knowledge-informed correlation metrics allow for a significant improvement in sampling efficiency over other methods.

TABLE 1
Information gain (D_{KL}) for three competing
reference point determination techniques:

| | | Improvement |
|---|---|---|
| Technique | D_{KL} | over RS |
| Random Sampling (RS) | 0.155 | — |
| Maximize distance for trivial metric | 0.169 | 8.6% |
| Maximize distance for correlation metric | 0.179 | 15.3% |

Exemplary Applications, Benefits, and/or Advantages of One or More Embodiments Described Above

One or more embodiments disclosed herein provides for automatically selecting efficient reference simulations in a computer simulation of relevant physics or scientific processes (e.g., by determining reference points), to enable the creation or development of a machine learning or artificial intelligence based computer simulation, reduced order model, digital twin, surrogate model, or data model.

One or more embodiments disclosed herein for automatically determining reference points (input parameters) for computer simulation models, enables improved (approaching optimality) efficient simulation conditions and/or simulation outputs and/or performance.

One or more embodiments disclosed herein applies to independent and/or non-independent variables for simulations.

One or more embodiments disclosed herein does not require the execution of any computer simulations to first acquire output data for a physical system under test in order to determine reference points. One or more embodiments disclosed herein does not require prior collection (e.g., by sensor) of output data for a physical system under test in order to determine reference points.

One or more embodiments disclosed herein employs meshes or other descriptions of simulation geometry, materials, or boundary conditions.

One or more embodiments disclosed herein may operate with generic computer simulations, such as Finite Element Analysis (FEA), including Computational Fluid Dynamics (CFD) or others.

One or more embodiments disclosed herein computes distance metrics in parameter space without first running simulations, based on generalized difference metrics computed on simulation conditions.

One or more embodiments disclosed herein provides for improved (approaching optimality) physics-based sampling of reference simulations (determination of reference points) for a fixed number of reference samples, e.g., as determined by user constraints and/or computational capacity limitations.

One or more embodiments disclosed herein provides for improved (approaching optimality) physics-based sampling of reference simulations for a varying number of reference samples.

One or more embodiments disclosed herein provides for optimal individual sample selection (determination of reference points) given a fixed number of samples.

One or more embodiments disclosed herein may be applied to parameter spaces with arbitrary constraints, such as boundaries and inequalities. Such inequalities may be satisfied by the parameters.

One or more embodiments disclosed herein increases information gain, as computed by the relative entropy, of Kullback-Leibler divergence, and provides improved results when compared with techniques that employ random search and/or naive distance maximization.

While various novel features of the invention have been shown, described and pointed out as applied to particular embodiments thereof, it should be understood that various omissions and substitutions and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the description of system components are for illustrative purposes to facilitate a full and complete understanding and appreciation of the various aspects and functionality of particular embodiments of the invention as realized in system and method embodiments thereof. Those skilled in the art will appreciate that the invention may be practiced in other than the described embodiments, which are presented for purposes of illustration and not limitation. Variations, modifications, and other implementations of what is described herein may occur to those of ordinary skill in the art without departing from the spirit and scope of the present invention and its claims.

What is claimed is:

1. A system of one or more computing devices comprising one or more processors and one or more non-transitory storage devices for storing instructions, wherein execution of the instructions by the one or more processors causes the one or more computing devices to:
receive a parameter space definition;
determine a correlation metric on a parameter space using the parameter space definition;
determine a loss function using the correlation metric;
compute a set of reference points using the loss function;
generate one or more sensed outputs using the computed reference points; and
update a learning model of a machine learning development architecture using a training vector comprised of the reference points and sensed outputs.

2. The system of claim 1, wherein the correlation metric is determined using a derivative of a scalar function, and the scalar function assigns a scalar value to every point in the parameter space to approximate one or more of the sensed outputs.

3. The system of claim 2, wherein the scalar function is a geometric function of the points in the parameter space, and the geometric function includes a volume or an area.

4. The system of claim 2, wherein the scalar function is a weighted sum of a plurality of geometric functions, the weights based on one or more parameters in the parameter space.

5. The system of claim 1, wherein the loss function is a maxim in function.

6. The system of claim 1, wherein the loss function includes a constraint.

7. The system of claim 6, the constraint includes bounds on or more parameters in the parameter space.

8. A method implemented via execution of computing instructions configured to run at one or more processors and configured to be stored at non-transitory computer-readable media, the method comprising:
receiving a parameter space definition;
determining a correlation metric on a parameter space using the parameter space definition;
determining a loss function using the correlation metric;
computing a set of reference points using the loss function;
generating one or more sensed outputs using the computed reference points; and
updating a learning model of a machine learning development architecture using a training vector comprised of the reference points and sensed outputs.

9. The method of claim 8, wherein the correlation metric is determined using a derivative of a scalar function, and the scalar function assigns a scalar value to every point in the parameter space to approximate one or more of the sensed outputs.

10. The method of claim 9, wherein the scalar function is a geometric function of the points in the parameter space, and the geometric function includes a volume or an area.

11. The method of claim 9, wherein the scalar function is a weighted sum of a plurality of geometric functions, the weights based on one or more parameters in the parameter space.

12. The method of claim 8, wherein the loss function is a maxim in function.

13. The method of claim 8, wherein the loss function includes a constraint.

14. The method of claim 13, the constraint includes bounds on or more parameters in the parameter space.

15. A computer program product, the computer program product comprising a non-transitory computer-readable medium including instructions for causing a computer to:
receive a parameter space definition;
determine a correlation metric on a parameter space using the parameter space definition;
determine a loss function using the correlation metric;
compute a set of reference points using the loss function;
generate one or more sensed outputs using the computed reference points; and
update a learning model of a machine learning development architecture using a training vector comprised of the reference points and sensed outputs.

16. The computer program product of claim 15, wherein the correlation metric is determined using a derivative of a scalar function, and the scalar function assigns a scalar value to every point in the parameter space to approximate one or more of the sensed outputs.

17. The computer program product of claim 16, wherein the scalar function is a geometric function of the points in the parameter space, the geometric function, including a volume or an area.

18. The computer program product of claim 15, wherein the loss function is a maxim in function.

19. The computer program product of claim 15, wherein the loss function includes a constraint.

20. The computer program product of claim 19, the constraint includes bounds on or more parameters in the parameter space.
